(19) United States
(12) Patent Application Publication
(10) Pub. No.: US 2025/0242319 A1
(43) Pub. Date: Jul. 31, 2025

(54) MIXER FOR MIXING AT LEAST TWO MATERIALS AND MIXING AND DISPENSING ASSEMBLY

(71) Applicant: medmix Switzerland AG, Haag (CH)

(72) Inventors: Joachim SCHOCK, Winterthur (CH); Jim GIGER, Grabs (CH); Carsten DEGENDORFER, Zurich (CH)

(21) Appl. No.: 18/853,099

(22) PCT Filed: Mar. 31, 2023
(86) PCT No.: PCT/EP2023/058448

§ 371 Date: Sep. 30, 2024

(30) Foreign Application Priority Data
Apr. 1, 2022 (EP) 22166368.5

(51) Int. Cl. B01F 35/40; B01F 25/431; B01F 101/00

(52) U.S. Cl. CPC B01F 35/40; B01F 25/431; B01F 2101/2305

(57) ABSTRACT

A mixer includes a mixer housing, a mixing element, an alignment element and a connection element. The mixing element has a first end and a second end opposite the first end, a longitudinal axis extending therebetween, first and second entry openings arranged at the first end and an outlet opening arranged at the second end, the mixing element further being arranged at least partly within the mixer housing. The alignment element aligns the mixer at a predetermined angle relative to the cartridge. The connection element connects the mixer to a cartridge by a form-fitting connection, and the connection element is a click connection or a snap lock connection.

### PRIORITY

This Application is a U.S National Stage application of International Application No. PCT/EP2023/058448, filed Mar. 31, 2023, which claims priority to European Application No. 22166368.5, filed Apr. 1, 2022, the contents of each of which are hereby incorporated by reference.

### BACKGROUND

### Technical Field

The disclosure relates to a mixer for mixing at least two materials as well as to a mixing and dispensing assembly.

### Background Information

Mixers for mixing two materials with one another as well as mixing and dispensing assemblies including such mixers are commonly known and widely used for example in the field of two component dispensers. Usually such assemblies comprise one or two cartridges comprising two outlets that are connected to the mixer. Upon use of the assembly, the two materials stored inside the one respectively two cartridges are urged towards the outlets such that they are dispensed from the cartridge(s) into the mixer.

Inside the mixer, the two materials are mixed with one another before the resulting mixed material is dispensed via a dispensing outlet at a front end of the mixer.

For reasons of sustainability, nowadays mixers are often produced as reusable parts such that only the cartridges need to be replaced once they are empty. Apart from making such a concept more sustainable, this additionally lowers the cost of the assemblies for the user as one does not need to buy a new mixer with every new cartridge.

### SUMMARY

In view of the above it has become necessary to provide connection means (or device) configured to connect the mixer and the one or two cartridges with one another such that the mixer cannot fall off the cartridge(s) when the two materials are urged into the mixer. Conventionally known connection means are for example simple plug-in connections that are easy to handle.

One disadvantage of such commonly known mixing assemblies is that the connection ten cannot withstand the high (shear) forces that act on the mixer when materials of high viscosities are urged into and mixed inside the mixer such that the connection between the mixer and the cartridge(s) leaks. In some cases, the mixer even disconnects from the cartridge unintentionally upon use.

Another disadvantage of such conventionally known mixing assemblies is that they are often not suitable for applications where materials are supposed to be mixed at an uneven ratio, i.e. a ratio that is not 1:1. For such cases special mixers have already been developed. However, with such special mixers the alignment between the mixer and the cartridge(s), especially the outlets of the cartridge(s), is crucial in order for the mixer to be able to mix the two materials at the predetermined uneven ratio.

It is therefore an object of the disclosure to provide a mixer as well as a mixing and dispensing assembly which enable a secure and correct connection as well as alignment between a mixer and a cartridge. This object is solved by the subject matter of the independent claims.

In particular, the mixer according to the disclosure is configured to be connected to a cartridge, and the mixer comprises a mixer housing and a mixing element having a first end and a second end, a longitudinal axis extending therebetween, at least two entry openings arranged at the first end and one outlet opening arranged at the opposite second end of the mixer. The mixing element is further arranged at least partly, in particular completely, within the mixer housing. The mixer further comprises at least one alignment element configured to align the mixer at a predetermined angle relative to the cartridge, and connection means configured to connect the mixer to the cartridge by a form-fitting connection, wherein the connection means are designed as a click connection and/or a snap lock connection.

Hence, one advantage of the disclosure is that the mixer according to the disclosure fixedly and safely secures the mixer to the cartridge by providing a form-fitting connection, i.e. a click connection and/or a snap lock connection. Thus, even if high pressures would act on the mixer in a dispensing direction, which can be caused by the materials stored inside the cartridge being compressed towards the mixer, the mixer cannot unintentionally detach from the cartridge. For this reason, the form fitting connection of the mixer has proven to be particularly suitable as it provides both a secure connection that can withstand comparatively high pressures as well as an easy way of handling such that the user can easily attach and detach the mixer to and from the cartridge.

Generally, it could also be possible that the connection means could even be configured such that they align the mixer at a predetermined angle with respect to the cartridge. This can be advantageous, or in some cases even necessary, if the two materials to be mixed comprise, for example, different densities and/or viscosities, and/or if the two materials should be mixed in an uneven ratio with respect to one another.

According to the disclosure the mixer further comprises at least one additional alignment element configured to align the mixer at a predetermined angle relative to the cartridge.

By providing an additional alignment element apart from the connection means, the disclosure can ensure that the mixer can only be aligned, and thereby also connected, to the cartridge in a particular way, i.e. at a particular angle with respect to the cartridge. In some cases it might even be one single particular angle. This can be done, for example, by configuring the alignment element of the mixer such that it engages with another corresponding alignment element of the cartridge.

In this connection it should be noted that generally the alignment element can be designed in various ways. In some embodiments it can be an alignment projection configured to align with another corresponding alignment projection. In other embodiments the alignment element of the mixer can be configured to engage with a corresponding alignment recess of the cartridge. In yet other embodiments the alignment element can also be configured such that it engages with a corresponding alignment projection of the cartridge by comprising, for example, an engagement recess. Thus, it can be seen that the alignment element can be designed in a plurality of different ways.

Hence, the disclosure provides a mixer with which both the alignment of the mixer with respect to a cartridge as well as the connection of the mixer to the cartridge can be improved with respect to prior art devices.

The disclosure is further defined by the features disclosed herein.

According to a first embodiment the connection means can be arranged at the mixer housing. The arrangement of the connection means at the mixer housing has the advantage that it does not matter what kind of mixing element is used for the mixer. It is commonly known that the mixing elements can vary depending on the precise application, i.e. for example depending on the materials to be mixed. By providing the connection means at the mixer housing the mixer can always be securely connected to the cartridge independently of what kind of mixing element is arranged within the mixer housing.

According to another embodiment the mixer further comprises at least one release element configured to release the connection, in particular the click connection, to detach the mixer from the cartridge. Such a release element can, for example, be pressed, rotated and/or pulled in order to release the connection of the mixer. This provides a particular easy way of detaching the mixer from the cartridge.

The release element can further be arranged at the mixer housing, in particular at an outer surface of the mixer housing. This has the advantage that the release mechanism does not depend on the type of mixing element which is arranged in the mixer housing. Hence, the release mechanism, i.e. the release element, can be used universally with all kinds of mixing elements.

According to another embodiment the release element is configured as a wing configured to be pressed against or pulled away from the connection means to release the form-fitting connection means. This makes it particularly easy for the user to release the connection of the mixer as they only need to press or pull the wing, preferably against or away from the mixing element, in order to release the connection.

In some embodiments the mixer comprises at least two release elements arranged opposite from one another that are configured to release the form-fitting connection of the connection means. Hence, for releasing the connection of the connection means, the two release elements can be pressed towards or pulled away from each other. Such arrangements are easy to use such that a user immediately understands how to release the connection of the mixer without the need of further help.

According to another embodiment the connection means are arranged at the at least one release element, in particular at a surface facing the cartridge. By providing the connection means at the at least one release element, the complete connection and release mechanism can be provided at one single component of the mixer. This helps simplifying the production of the mixer.

According to a further embodiment the alignment element is arranged at the mixer housing, in particular at an outer surface of the mixer housing, preferably between the two release elements. As already mentioned above in connection with some other features of the mixer, this helps making the mixer according to the disclosure universally applicable as it does not matter what kind of mixing element is arranged inside the mixer housing. Furthermore, by arranging the alignment element at the mixer housing, maybe even at an outer surface of the housing, a user can see and feel the alignment element when handling the mixer such that they can easily understand how to align the mixer correctly with respect to the cartridge to which it is supposed to be attached to.

The alignment element can further comprise at least one alignment surface. The alignment surface can, for example, be arranged such that it rests on a corresponding second alignment surface that is arranged at the cartridge. This enables the user to easily understand how the mixer is supposed to be aligned with respect to the cartridge.

According to a further aspect of the disclosure a mixing and dispensing assembly for mixing and dispensing at least two materials is provided with the assembly comprising a mixer for mixing the at least two elements, and a cartridge, in particular a two-component cartridge, wherein the mixer comprises a mixer housing, a mixing element having a first end and a second end, a longitudinal axis extending therebetween, at least two entry openings arranged at the first end and one outlet opening arranged at the opposite second end of the mixer, the mixing element further being arranged at least partly, in particular completely, within the mixer housing, and at least one alignment element configured to align the mixer at a predetermined angle relative to the cartridge, and connection means configured to connect the mixer to the cartridge by a form-fitting connection, wherein the connection means are designed as a click connection and/or a snap lock connection.

The above features and advantages mentioned in connection with the mixer according to the disclosure can equally apply to the mixing and dispensing assembly according to the disclosure.

That is, the disclosure provides an assembly with which the connection and alignment between the mixer and the cartridge can be considerably improved.

According to an embodiment of the disclosure the cartridge can comprise a cartridge head having at least two outlet openings, with the cartridge head further being configured to be connected to the mixer at the predetermined angle. The head part can in particular be a solid head part. This has the advantage of separating the connection mechanism from the cartridge container itself such that, for example, collapsible cartridges can be used, which comprise a solid head part to which the mixer is then attached to.

According to a further embodiment the cartridge, in particular the cartridge head, can comprise connection elements designed complementary to the connection the mixer and configured to engage with the connection the mixer. Thus, the connection elements of the cartridge and the connection the mixer together can form the form-fitting connection, i.e. the click connection and/or the snap lock connection.

According to another embodiment of the disclosure the cartridge can further comprise an alignment portion configured to rest on the alignment element of the mixer, in particular on an alignment surface of the mixer. Hence, the alignment portion can, for example, be arranged such that it rests on a corresponding second alignment element of the mixer. This enables the user to easily understand how the mixer is supposed to be aligned with respect to the cartridge.

In an alternative embodiment, the alignment portion can also be configured such that it engages with the alignment element of the mixer by, for example, enclosing it from two or more sides, or by being enclosed by the alignment element from two or more sides. Hence, the alignment portion can be designed and/or configured in various ways as long as it is configured to engage with the alignment element of the mixer to which the cartridge is supposed to be attached to.

In this connection it should be noted that the alignment portion can also comprise at least one alignment surface configured to align the cartridge with respect to the mixer by leaning against the alignment element of the mixer, in particular against the alignment surface of the alignment element of the mixer.

### BRIEF DESCRIPTION OF THE DRAWINGS

Embodiments of the disclosure are described in the following description of the Figures.

FIG. 1 is an exploded view of a mixing assembly according to the disclosure;

FIG. 2 is a detailed view of the connection between the mixer and the cartridge;

FIG. 3A is a perspective view and FIG. 3B is a cross section of the connection between the mixer and the cartridge in a locked position;

FIGS. 4A and 4B illustrate four cross sections as well as corresponding exploded views of the ledge;

FIGS. 5A and 5B illustrates side views of the connection between the mixer and the cartridge;

FIG. 6A is a perspective side view of a further mixing configuration and FIG. 6B is a top view of the inlet section thereof in accordance with a first exemplary embodiment;

FIGS. 7A and 7B are perspective side views of a mixing configuration and FIG. 7C is a top view of the inlet section thereof in accordance with a second exemplary embodiment;

FIGS. 8A and 8B are perspective side views of a mixing configuration and a FIG. 8C is top view of the inlet section thereof in accordance with a third exemplary embodiment;

FIGS. 9A and 9B are perspective side views of a mixing configuration and FIG. 9C is a top view of the inlet section thereof in accordance with a fourth exemplary embodiment;

FIG. 10 is a cross sectional side view of the inlet section of a mixing configuration provided with two one-way valves for the inlet openings;

FIG. 11A-11C are three exemplary embodiments of preferable mixing configurations;

FIG. 12 is an exploded view of a static mixer in accordance with a first supplementary aspect having two mixing elements (two-hole version);

FIGS. 13-15 are perspective views illustrating alternate embodiments of the mixing elements of FIG. 12;

FIGS. 16A and 16B are perspective views illustrating mixing elements with two separating flanges per section (three-hole version);

FIG. 17 is a cross-sectional view illustrating a longitudinal section through a mixer with the mixer elements of FIGS. 16A and 16B;

FIGS. 18A and 18B are perspective views illustrating deflection plates for mixing elements with three separating flanges (four-hole version);

FIG. 19 is a partial perspective view illustrating mixing elements for a square tube;

FIG. 20 is a diagram with measured results for the coefficient of variation s/x⁻ (with x⁻=0.5);

FIG. 21A is a perspective view of a section of a mixer structure which has only mixing-active chambers;

FIG. 21B is a perspective view of the geometrical construction of the mixer structure of FIG.;

FIG. 21C is a cross-section through the structure of FIG. 21A;

FIG. 22 is a first modification of the mixer structure shown in FIG. 20;

FIG. 23 is a second modification of the mixer structure shown in FIG. 21A;

FIG. 24 is a perspective view of a first mixer structure in accordance with the aspect with re-layering chambers;

FIG. 25 is a perspective view of a second mixer structure in accordance with the aspect with re-layering chambers;

FIG. 26 is an unwrapped view into a plane of the edges lying at the periphery of the mixer structure in accordance with FIG. 20;

FIG. 27 is a corresponding unwrapped view for a mixer structure in accordance with FIG. 24;

FIG. 28 is an unwrapped view for a mixer structure in accordance with FIG. 25;

FIG. 29 is a perspective view of a mixer structure with an additional, advantageous, structure element;

FIG. 30 is a perspective view of a first laterally reinforced mixer structure;

FIG. 31 is a perspective view of a second mixer structure with lateral reinforcement;

FIG. 32 is a schematic representation of a mixer structure with a bundle of four chambered strings;

FIG. 33 is a schematic representation of a mixer structure with nine chambered strings;

FIG. 34 is a schematic representation of a mixer structure with sixteen chambered strings;

FIG. 35 is a first exemplary embodiment of a mixer of the supplementary third aspect in a perspective view;

FIG. 36 is the starting position prior to mixing;

FIG. 37 is a corresponding mixing diagram;

FIG. 38 shows a flow diagram of the mixing operation;

FIG. 39 is the mixer of FIG. 35 in the inverse flow direction;

FIG. 40 is the starting position of the mixer of FIG. 39 prior to mixing;

FIG. 41 is a mixing diagram relating to FIG. 40;

FIG. 42 is a flow diagram of the mixer of FIG. 39 in the mixing operation;

FIG. 43 is a second exemplary embodiment of a mixer of the aspect in a perspective view;

FIG. 44 is the starting position prior to mixing;

FIG. 45 is a diagram of the mixing operation in the mixer of FIG. 43;

FIG. 46 is a flow diagram of the mixing operation in the mixer of FIG. 43;

FIG. 47 is a combination of mixing elements according to the disclosure and of a mixing helix known per se in the prior art;

FIG. 48 is a detail of an alternative embodiment of FIG. 43;

FIG. 49 is another exemplary embodiment of a mixer of the disclosure;

FIG. 50 is a flow diagram of the mixing operation in the mixer of FIG. 49;

FIG. 51 is an enlarged detail of the mixer of FIG. 49;

FIGS. 52A and 52B illustrate a first type of static mixer in a first type of mixer housing;

FIGS. 53A-53E illustrate a first type of mixer inlet section;

FIGS. 54A-54C illustrate a first type of mixing element;

FIGS. 55A and 55B are perspective part views of the first type of static mixer;

FIGS. 56A and 56B are a second type of static mixer in a second type of mixer housing;

FIGS. 57A-57E illustrate a second type of mixer inlet section;

FIGS. 58A-58C illustrate a second type of mixing element;

FIGS. 59A and 59B are perspective part views of the second type of static mixer;

FIG. 60 is a dispensing apparatus;

FIGS. 61A and 61B are sectional views of molding devices;

FIG. 62 is a longitudinal section of a mixer;

FIG. 63 is a view of the inlet end of the mixer;

FIG. 64 is a longitudinal section of a cartridge;

FIG. 65 is a top view of the cartridge of FIGS. 53A-53E with distanced outlets and a ring-shaped bayonet means;

FIG. 66 is a longitudinal section of a cartridge having two containers with different cross-sectional areas;

FIG. 67 is a top view of the cartridge of FIG. 66 with distanced outlets and the ring-shaped bayonet means;

FIG. 68 is a longitudinal section of a mixer;

FIG. 69 is a view of the inlet end of the mixer;

FIG. 70 is a longitudinal section of a cartridge with distanced outlets and the ring-shaped bayonet means;

FIG. 71 is a top view of the cartridge of FIG. 70 with a nose piece;

FIG. 72 is a top view of a coupling ring;

FIG. 73 is a section of the coupling ring of FIG. 72;

FIG. 74 is a longitudinal section of a variant of the mixer of FIGS. 68 and 69 attached to the cartridge of FIGS. 66 and 67 having containers with different cross-sectional areas;

FIG. 75 is a longitudinal section of a cartridge with distanced outlets;

FIG. 76 is a top view of the cartridge of FIG. 75;

FIG. 77A is a view on the mixer side of a locking ring to be attached to the cartridge;

FIG. 77B is a view on the cartridge side of the locking ring of FIG. 77A;

FIG. 78 is a section of the looking ring according to the line XVII-XVII of FIG. 77B;

FIGS. 79 and 80 are two longitudinal sections at 90° to each other a mixer attached to the cartridge of FIG. 75 with the locking ring of FIGS. 77A to 788, in the locked position;

FIGS. 81 and 82 are a first embodiment of a two part closure cap in a longitudinal section and a view on its cartridge side face;

FIGS. 83 and 84 are a second embodiment of a one part closure cap for use with a coupling ring in a longitudinal section and a view on its cartridge side face;

FIGS. 85 and 86 are a third embodiment of a one part closure cap for use with a locking ring attached to the cartridge in a longitudinal section and a view on its cartridge side face;

FIG. 87 is a longitudinal section of a mixer attached to a partially shown cartridge;

FIG. 88 is a view of the inlet end of the mixer;

FIG. 89 is a top view of the cartridge of FIG. 87;

FIG. 90 is a longitudinal section of a mixer attached to a partially shown cartridge;

FIG. 91 is a view of the inlet end of the mixer;

FIG. 92 is a top view of the cartridge of FIG. 90;

FIG. 93 is a longitudinal section of a mixer attached to a partially shown cartridge;

FIG. 94 is a view of the inlet end of the mixer;

FIG. 95 is a top view of the cartridge of FIG. 93;

FIG. 96 is a longitudinal section of a mixer attached to a partially shown cartridge;

FIG. 97 is a top view of the cartridge of FIG. 96;

FIG. 98 is a view of the inlet end of the mixer;

FIG. 99 is a longitudinal section of a mixer attached to a partially shown cartridge;

FIG. 100 is a top view of the cartridge of FIG. 99;

FIG. 101 is a view of the inlet end of the mixer;

FIG. 102 is a longitudinal section of a mixer;

FIG. 103 is a longitudinal section of a coupling ring;

FIG. 104 is a top view of the coupling ring of FIG. 103;

FIG. 105 is a longitudinal section of the mixer attached to a partially shown cartridge via the coupling ring;

FIG. 106 is a longitudinal section of a mixer attached to a partially shown cartridge;

FIG. 107 is a top view of the cartridge of FIG. 102;

FIG. 108 is a view of the inlet end of the mixer;

FIG. 109 is a top view of a cartridge like in FIG. 100, with an additional coding means;

FIG. 110 is a section of the inlet end of a mixer like in FIG. 99, with an additional coding means;

FIG. 111 is a view of the inlet end of the mixer of FIG. 110;

FIGS. 112 and 113 are variants of the coding means at the cartridge and mixer;

FIGS. 114 and 115 are further variants of the coding means at the cartridge and mixer;

FIGS. 116 and 117 are further variants of the coding means at the cartridge and mixer; and

FIGS. 118 and 119 are further variants of the coding means at the cartridge and mixer.

### DETAILED DESCRIPTION

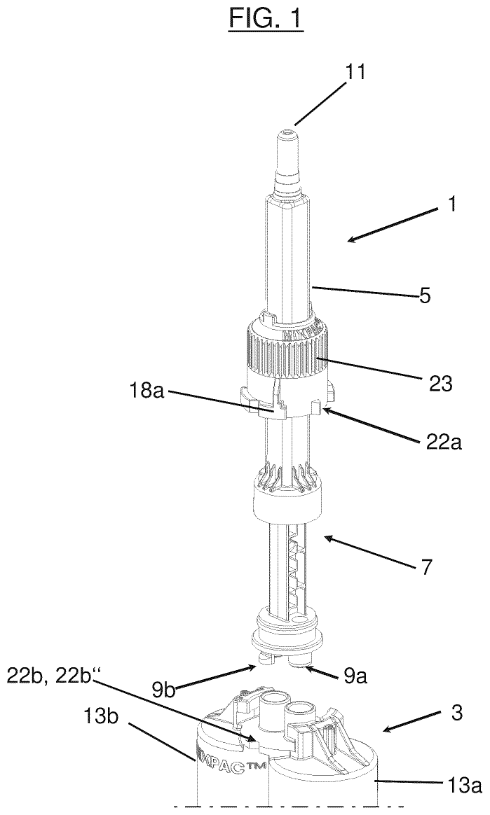

FIG. 1 shows a perspective view of a mixer assembly according to the disclosure comprising a mixer 1 and a cartridge 3. Generally, the cartridge 3 can be any kind of cartridge suitable for storing two or more materials that are supposed to be mixed. Often, such cartridges 3 comprise one or more flexible cartridge containers that can be compressed to urge the materials stored inside the containers towards their respective cartridge outlets 15a, 15b. The cartridge 3 further comprises a cartridge head 29 having the cartridge outlets 15a, 15b with the outlets 15a, 15b being arranged at an end plate 30 of the cartridge head 29.

The mixer 1 comprises corresponding entry openings, i.e. inlet openings 9a, 9b, which, upon connection of the mixer 1 with the cartridge 3, are aligned with one another.

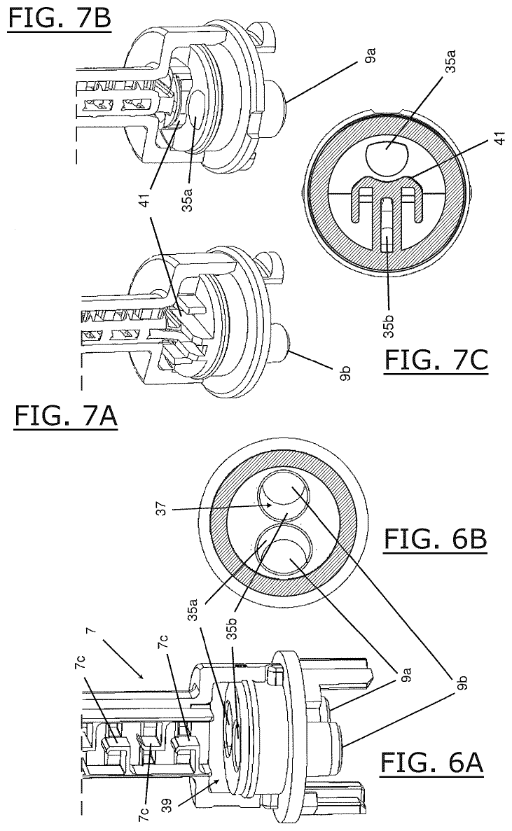

The mixer 1 further comprises a mixer housing 5 with an outlet/dispense opening 11 and a mixing element 7 which can be configured as a mixing configuration 7. The mixing configuration 7 can be configured in different ways with some of which being described in connection with FIGS. 6A-119.

The mixer further comprises an alignment element 20a configured to align the mixer 1 at a predetermined angle relative to cartridge 3. This is done by providing a corresponding alignment portion 20b at the cartridge 3 that engages with the alignment element 20a of the mixer 1.

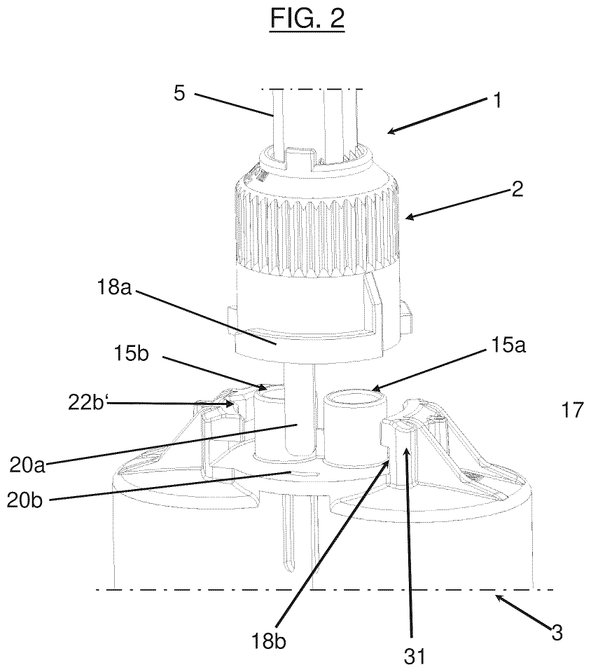

FIG. 2 shows two different embodiments of the alignment element 20a and corresponding alignment portion 20b. The embodiment of the left part of the Figure shows a mixing and dispensing assembly with the alignment element 20a and alignment portion 20b both being configured as protrusions such that they rest on top of each other once the two components are connected with one another. The embodiment of the right part of the Figure, on the hand, shows a mixing and dispensing assembly with the alignment element 20a being configured such that it overlaps the alignment portion 20b of the cartridge 3 by enclosing it from three sides.

In general, the alignment means 19, i.e. the alignment element 20a and the alignment portion 20b, can be configured in several different ways as long as they ensure that the mixer 1 and the cartridge 3 are connected with one another at one particular angle. This is crucial for applications where the two components are supposed to be mixed with one another at an uneven ratio, i.e. a ratio that differs from 1:1.

In order to fixedly connect the mixer 1 with the cartridge 3, in particular with the cartridge head 29, the mixing and dispensing assembly comprises connection means 17 configured to connect the mixer 1 to the cartridge 3 by a form fitting connection, i.e. a click and/or a snap lock connection. The connection means 17 can both be

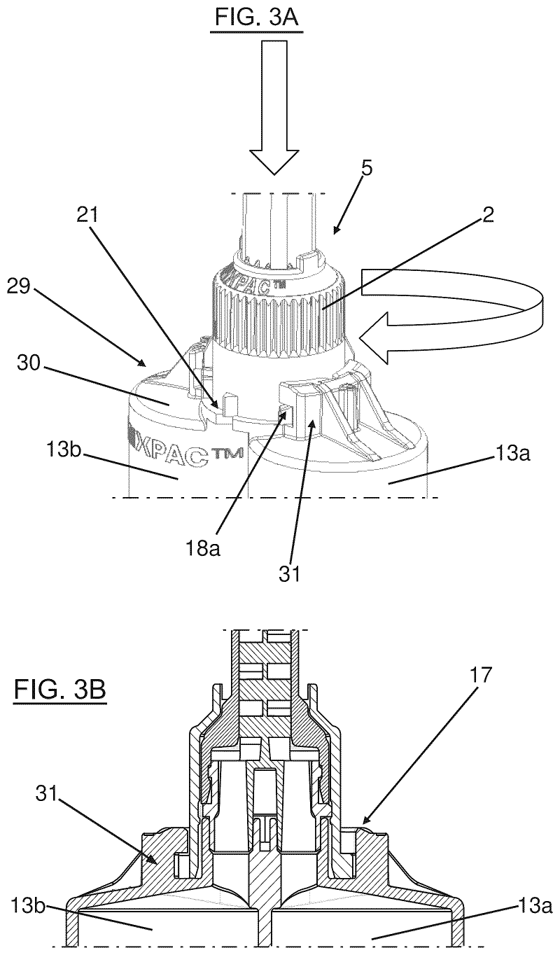

In the embodiments shown in the Figures, the connection means 17 comprise a connection protrusion 18a that is configured to engage with a connection recess 18b (see e.g. FIGS. 3A and 3B). The upper part of FIGS. 3A and 3B shows a cross section with the connection means 17 being in a closed position, i.e. with the connection protrusion 18a being held by the connection recess 18b. The lower part of FIGS. 3A and 3B shows a cross section with the connection means 17 being in an open position, i.e. with the connection protrusion 18a being released from the connection recess 18b.

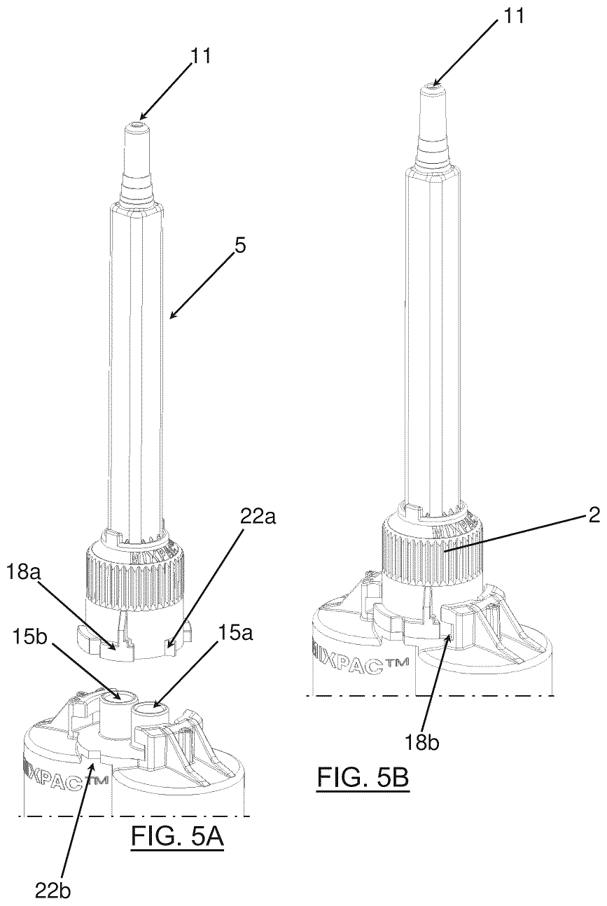

In order to bring the connection means 17 in a closed and/or open position the mixer 1 comprises two release elements 21 in the form of wings 21. For this reason, the connection means 17, i.e. a connection protrusion 18a is arranged at an inner surface of each wing 21 (see FIGS. 5A and 5BFIG.) such that upon pressing or pulling of the wing(s) 21 the connection means 17 can be brought in an open or closed position.

In this connection it is noted that it can either be possible that the connection means 17 automatically move into the closed position when the mixer I engages with the cartridge 3. Alternatively, it could also be possible that the wings 21 have to be pressed against the mixer 1 in order to bring the connection means 17 in a closed position.

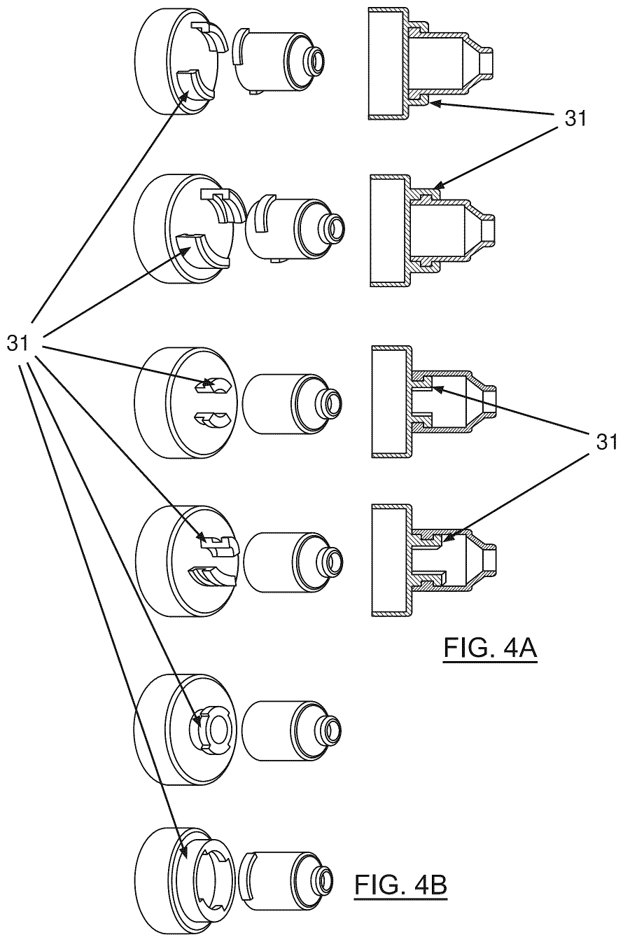

The embodiment shown in the Figures is configured such that the connection protrusion 18a automatically snaps into the connection recess 18b when the mixer 1 is brought into engagement with the cartridge 3 (i.e. it clicks). In order to release this connection, the wings 21 are pressed against each other such that the connection protrusion 18a slips out of the connection recess 18b, thereby bringing the connection means 17 in an open position (see FIGS. 3A and 3B FIG. and FIGS. 4A and 4B).

For this reason, i.e. for releasing the connection by using wings 21, the connection recess 18b can be arranged at the alignment protrusion 20a respectively the alignment portion 20b such that the connection protrusion 18a is arranged near the alignment protrusion 20a respectively the alignment portion 20b when the connection means 17 are in a closed position (see e.g. FIGS. 5A and 5B).

Hence, with the disclosure the mixer 1 and the cartridge 3 can be connected with one another in a particular simple, yet reliable way. Furthermore, by arranging release elements 21 that are configured to release the connection 17 between the mixer 1 and the cartridge 3 a user can easily detach the mixer 1 from, for example, an empty cartridge 3 in order to replace it.

Also, by arranging both the connection means 17 as well as the alignment means 19 at the mixer housing 5, and not at the mixer configuration 7 itself, it is not relevant what kind of mixer is used.

The above described mixing configuration 7 is configured to mix the components received via the inlet openings 9a and 9b when flowing from the inlet openings 9a and 9b along the mixing path through the mixer housing 5 to the dispense opening 11. Thus, a mixture of the two (or more) components can be dispensed at the dispense opening 11.

Three preferable exemplary embodiments for such a mixing configuration 7 are shown in FIGS. 11A to 11C. All of these exemplary embodiments for the mixing configuration 7 are formed of two sections with different mixing elements 7a, 7b and 7c, which results in a quite satisfying mixing of the component. However, also other combinations than the illustrated ones, in particular comprising more or less than two different sections and or other mixing elements can be implemented.

In FIG. 11A the so-called “T-Helix-Mixer” is illustrated. This mixing configuration 7 comprises T-like shaped mixing elements 7a in a first section of the mixing configuration 7 (seen along the mixing flow path) combined with helically shaped mixing elements 7b in a second section of the mixing configuration 7 (seen along the mixing flow path).

In FIG. 11B the so-called “Quadro-Helix-Mixer” is illustrated. This mixing configuration 7 comprises more or less cubic of L-shaped mixing elements 7c in a first section of the mixing configuration 7 (seen along the mixing flow path) combined with helically shaped mixing elements 7b in a second section of the mixing configuration 7 (seen along the mixing flow path).

In FIG. 11C the so-called “Quadro-T-Mixer” is illustrated. This mixing configuration 7 comprises more or less cubic or L-shaped mixing elements 7c in a first section of the mixing configuration 7 (seen along the mixing flow path) combined with T-like shaped mixing elements 7a in a second section of the mixing configuration 7 (seen along the mixing flow path). The cubic or L-shaped mixing elements 7c can be seen also in FIGS. 6A and 6B (referred to below).

In general, the components to be mixed with each other are liquids or have at least certain fluidity, and are stored in separate component reservoirs of the multi-component cartridge 3. Each of these component reservoirs is connected to its own outlet opening 15a or 15b.

To ensure a satisfying mixing of these components, it is not only possible to adapt the specific configuration and combination of the mixing elements 7a to 7c of the mixing configuration 7, but also to adapt the inlet section of the mixing configuration 7. Preferable configurations for the inlet sections in the vicinity of the inlet openings 9a and 9b of the mixing configuration 7 are illustrated in FIGS. 6A to 9C.

As illustrated in FIGS. 6A and 6B, the inlet section can be provided with two identical and round transitional openings 35a and 35b miss-aligned slightly with the inlet openings 9a and 9b. Such a configuration results in the formation of a first mixing chamber 37 between the inlet openings and the transitional openings 35a and 35b and of a second mixing chamber 39 between the transitional openings 35a and 35b and the mixing elements 7c.

As illustrated in FIGS. 7A and 7B, the inlet section can also be provided with a first small transitional opening 35a for a small inlet opening 9a and with a larger transitional opening 35b for a larger inlet opening 9b. As can be seen further, the transitional openings do not have to be round in cross section and can be aligned with the corresponding inlet openings 9a and 9b. Moreover, in particular the second mixing chamber 39 can be provided with an in particular T-like shaped inlay member 41 promoting the mixing of the components within the second mixing chamber 39.

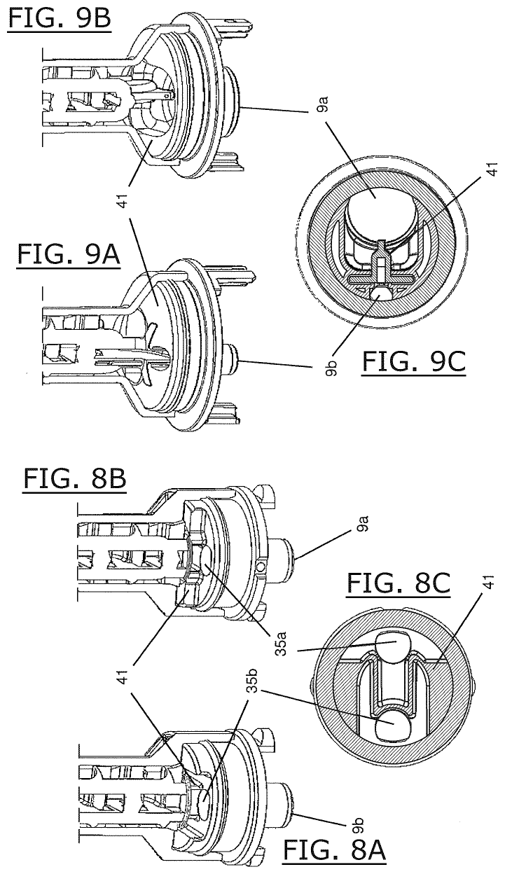

As further illustrated in FIGS. 8A and 8B two identical but non-round transitional openings 35a and 35b totally aligned or miss-aligned from the corresponding inlet openings 9a and 9b can be used. Furthermore, the inlay member 41 can have other shapes like a W-shape.

As further illustrated in FIGS. 9A and 9B, also configurations with a very complex inlay member 41 and not two separate mixing chambers are possible.

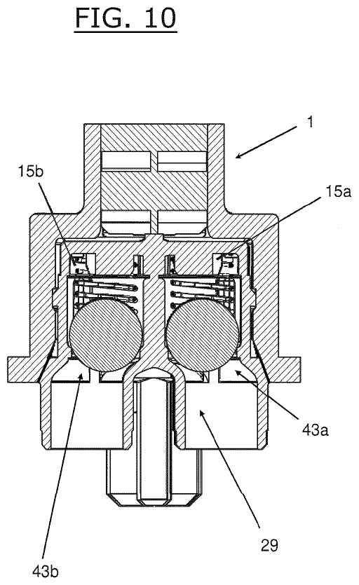

Finally, it is pointed to the fact that the cartridge head 29 can be provided with valves 43a and 43b, in particular with one-way valves, for the outlet openings 15a and 15b, preventing the mixture from the mixer to flow back onto the component reservoirs. Such a configuration is illustrated in FIG. 10.

In the following, several supplementary aspects for the present disclosure will be described. For each of these supplementary aspects, an independent set of figures with a specific set of reference numerals and designations of specific components are used. However, a skilled artisan should have no problem in identifying the respective correspondences throughout the various aspects.

For the present disclosure and for further delimitation thereof, in particular the features referring to the specific implementations of the provided mixing configurations are considered highly relevant. In particular the specific implementation of the mixing configurations in the connection area between the mixers and the multi-component cartridges, i.e. in the vicinity of the inlet openings, and the specific structural implementations of the mixing flow paths within the mixer housings are considered relevant as possible aspects for further delimitation of the present disclosure.

In the following, embodiments of a supplementary first aspect will be described with reference to the FIGS. 11A to 19:

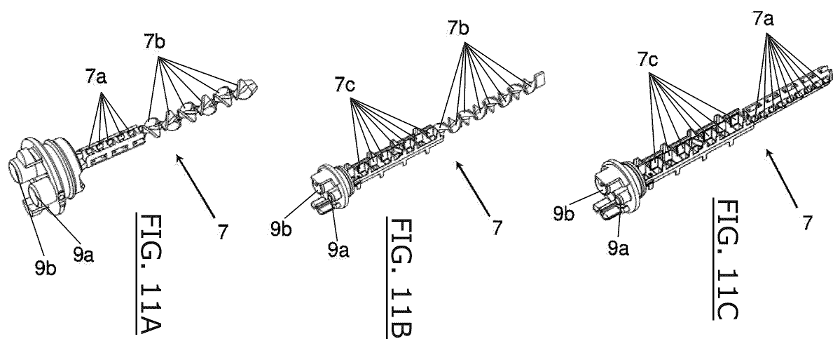

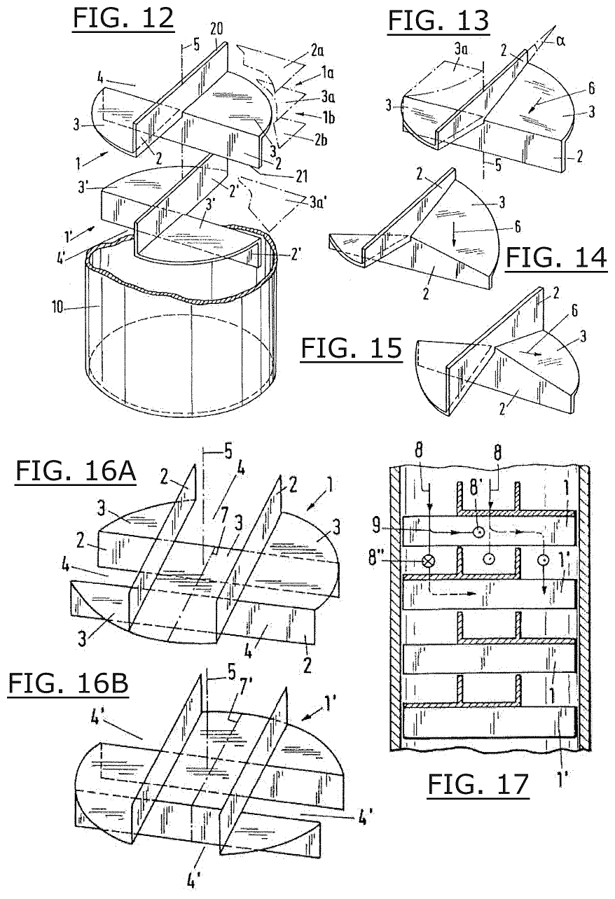

The mixing elements 1 and 1′ of FIG. 12 arranged in a tube 10 each comprise two separating flanges 2 and 2′, and two deflecting plates 3 and 3′ which lie in a plane 3a, 3a′ respectively indicated by the chain-dotted lines. The plane 3a lies perpendicular to the tube axis 5 and parallel to planes 2a and 2b, which define the upper edge 20 and the lower edge 21 of the separating flanges 2 respectively. The three planes 2a, 3a and 2b define and bound two sections 1a and 1b of the mixing element 1. To each section is assigned one of the two separating flanges 2 subdividing the section. The separating flanges 2 of the two sections 1a and 1b cross one another at right angles. The tube cross section is subdivided into four equal subareas by the separating flanges 2, where two of these subareas are covered by the deflecting plates 3. The two open subareas are provided as constrictions and passage holes 4 for the medium to be mixed.

The two successive mixing elements 1 and 1′ are formed substantially in the same way. However, mixing element 1 represents the mirror image of mixing element 1′. The neighbouring separating flanges 2 and 2′ cross one another; the open subareas 4 and 4′ are arranged in a mutually offset manner.

The deflecting plates 3 can also subtend an angle a with the cross-sectional plane 3a—see FIG. 13. This angle a is advantageously chosen to be not greater than 30°. FIGS. 1-3 and 1-4 show further embodiments with inclined surfaces. If the axis 5 is understood to be vertical, the arrow 6 in FIGS. 1-2 to 1-4 represents the fall line of a deflecting plate 3. In FIG. 13 this arrow 6 is parallel to the upper separating flange 2. In the exemplary embodiment of FIG. 14 the arrow 6 is tangential to a circular cylinder concentric with the axis 5. In the exemplary embodiment of FIG. 15 the arrow 6 is directed radially outwards.

FIGS. 16A and 16B show mixing elements 1 and 1′ in each of which two separating flanges 2 are respectively associated with a section bounded by the upper edges of the flanges 2 and the plates 3 and a section bounded by the plates 3 and the lower edges of the flanges 2, as analogous to 1a and 1b of FIG. 12 (not shown in FIGS. 16A and 16B). On both sides of each separating flange 2 is placed exactly one open subarea 4. The mixing element 1′ with the open subareas 4′ represents an immediately neighbouring element of the mixing element 1. The open subareas 4 and 4′ are arranged in a mutually offset manner. In the three-hole version (FIGS. 16A and 16B) the two mixing elements 1 and 1′ are identical and not mirror imaged as in the two-hole version (FIG. 12).

For efficient manufacture of the three-hole mixing body (FIGS. 16A and 16B) by the process of injection molding, the mixing elements can be divided into two halves. The boundaries between the half elements are shown in FIGS. 16A and 16B as chain-dotted lines 7 and 7′ respectively. Monolithic partial bodies each containing a series of such half elements can be constructed simply using two-part tools. The entire mixing body (1, 1′) is formed by joining together two matching monolithic partial bodies.

The longitudinal section of FIG. 17 shows the individual mixing elements 1 and 1′ alternately stacked closely upon one another. Spacings between individual neighbouring elements or between all elements can however also be provided. Mixing elements built in with spacing can be connected by connecting pieces to form a monolithic mixer.

In FIG. 17 the course of the flow of the medium to be mixed is also indicated by the arrows 8, 8′ and 8″. Arrow 8′ is perpendicular to the plane of the diagram and is directed forwards; arrow 8″—also normal—is directed towards the rear. The reference symbol 9 points toward a position at which the arrows indicate the creation of two partial streams.

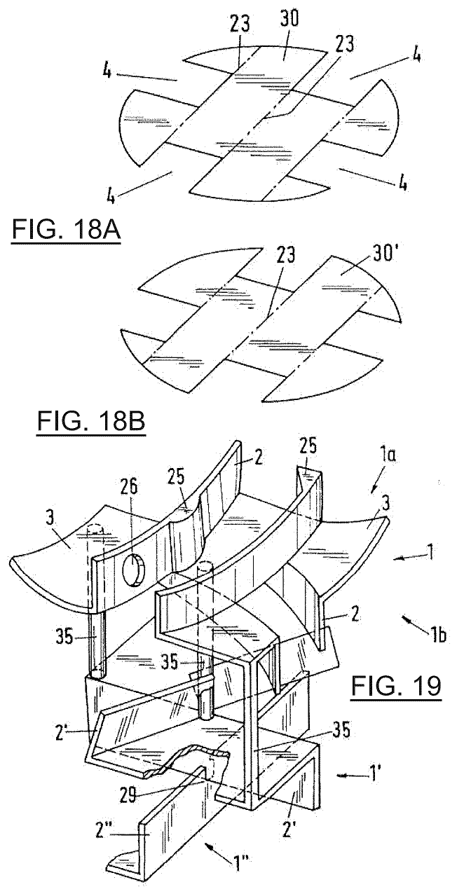

It is advantageous for the deflection plates 3 of each element (1, 1′) to lie in a common plane. In the presence of at least two separating flanges 2 per section (three-hole version) several deflection plates 3 can be joined together to form a common plate or a single plate 30 (four-hole version), as shown in FIGS. 16A and 16B and the corresponding FIGS. 18A and 18B for the four-hole version.

In each of FIGS. 18A and 18B only the single and common deflection plate 30 or 30′ is shown. The chain-dotted lines 23 represent the lower edges of the upper separating flanges. As in the previous two-hole version the neighbouring mixing elements are mirror images of one another.

In place of a circular cross section, the mixer can have a cross section of any other shape, for example that of a square. The angles of crossing between the neighbouring separating flanges 2, 2′ can also deviate from 90°. The sections 1a and 1b (see FIG. 12) can be of different lengths. It is advantageous for the length of the sections 1a and 1b to be in the range from D/8 to D; it is preferably D/4.

FIG. 19 illustrates what deviations from the simple form described above are conceivable. In this embodiment, connecting elements 35 are placed between the spaced mixing elements 1, 1′. The separating flanges 2 have additional elements 25, 26 as strengtheners or stream deflectors. Separating flanges 2′ and 2″ of neighbouring mixing elements 1′ and 1″ are fitted together at the position 29. Some of the separating flanges 2 and deflection plates 3 are nonplanar.

The mixing elements 1 and 1′ have different numbers of separating flanges 2 and 2′ persection 1a and 1b respectively, namely two and one respectively. One separating flange 2 has a recess 29. FIG. 19 is understood merely as illustrating individual features; this particular combination of all features listed in a single mixer does not preclude other combinations.

The tube 10 can also be shaped conically (not shown) so that it tapers in the direction of flow. In this case, the mixing bodies 1, 1′ must be constructed in differing sizes corresponding to the varying cross section.

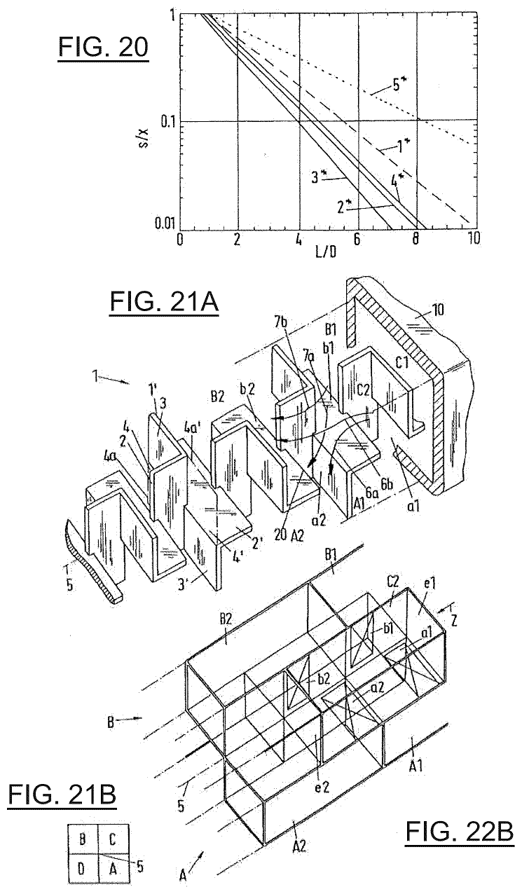

The diagram in FIG. 20 shows the dependence of the coefficient of variation s/x⁻ on L/D for x⁻ 0.5 in accordance with the above-mentioned experiments. x⁻ =0.5 means that the proportions of the components to be mixed are equally large. The reference symbols 1* to 5* refer to the mixer types that are listed in the above table.

The mixer which can be constructed monolithically of little material, can advantageously be constructed of an economical, combustible plastic by injection molding. This mixer is especially suitable for use as a one-way article.

The mixer can also be used to mix turbulently flowing media.

In the following, embodiments of a supplementary second aspect will be described with reference to the FIGS. 21A to 34:

The static mixer shown in FIG. 21A comprises a mixer structure 1 which is arranged in a tube 10. The mixer structure 1 is composed of mixing elements 1′, each of which consists of two separating flanges 2, 2′ and two deflection plates 3, 3′. In the plane of the deflection plates 3, 3′, there are two open subsurfaces 4, 4′, which have also been designated as passage holes.

The geometrical construction of the mixer structure 1—see FIGS. 21B and 21C—can be described as a pack or bundle of chambered strings A, B, C and D oriented in the direction of the Z-axis. The designations of the chambers are A1, A2, . . . B1, B2 . . . C1, C2, . . . and D1, D2, . . . These chambers are “mixing-active”; they each extend in the direction of the tube 10 between two closed ends e1, e2; and two mutually adjacent side walls of the mixing-active chambers contain four passages a1, b1, a2 and b2 (each with a surface marked with a cross in FIG. 21B) of alternating disposition. The chamber C2 is connected via the passages a1 and b1 to the two chambers A1, B1 lying upstream as well as via the passages a2 and b2 to the two chambers A2, B2 lying downstream. All the chambers in the mixer of FIG. 21A are mixing-active. In general, however, a mixing-active chamber can also be connected to other chambers (relayering or intermediate chambers, see further below).

The strings A and B-seen as cross-sections in FIG. 21C-have the same construction; string A can be brought to coincidence with string B by a 180° rotation about the z-axis (or the centerline 5). The same relationship exists between the strings C and D. The strings of a pair A, B are connected to the respective strings of the other pair C, D via the chamber passages a1, . . . The two string pairs differ in that the chambers of the one pair are arranged so as to be
displaced in the Z-direction by half a chamber length with respect to those of the other pair.

How the medium to be mixed is re-directed or reformed in the chamber C2 is indicated by the arrows 6a, 6b, 7a and 7b in FIG. 21A. Two medium flows emerge from the strings A and B through the entry passages a1 (arrows 6a, 6b) and b1
(arrows 7a, 7b) into the chamber C2 and thus into the string C, unite there and influence each other in their movement through the chamber C2. At the edge 20 near the passage exit a2 a first separation off of a first partial flow (arrows 6a, 7a)
takes place, which passes over into string A. The remaining partial flow (arrows 6b, 7b) enters into the string B via the exit passage b2. In the ideal case there is a uniform distribution, as indicated by the arrows, with each arrow corresponding to the same amount of transported mixing material.

The chambers of the mixer structure 1 are substantially in the shape of a rectangular prism and the passages are rectangular. The walls are executed in the shape of plates. The walls need not have constant wall thicknesses, however; they can for example be executed with a wedge shape as illustrated in FIG. 22.

Curved shapes can also be used for the walls, as is illustrated in FIG. 23, in order that the pressure drop in the mixing material produced by the mixer structure be smaller than that with the mixer structure of FIG. 21A.

In additional to the mixing-active chambers the mixer structure 1 contains “re-layering chambers” S1, S2—see FIG. 24—and S1′, S2′ (not visible in FIG. 24). The chamber S1 has two entry passages a1 and b1 as well as an exit passage t1. The passage t1 forms the connection to an intermediate chamber T (or transfer chamber) which has only one entry, namely the passage t1, and one exit t2 (not visible). A corresponding intermediate chamber T′ with an entry t1′ and an exit t2′ is arranged diametrically with respect to T. The intermediate chambers T and T′ lead further to re-layering chambers S2′ (not visible) and S2 respectively, each of which contains one entry passage and two exit passages. For S2 these passages are the passages designated by t2′ and a2 and b2 respectively. The chambers S1 and S2′ and the chambers S1′ and S2 each form a pair connected by a transfer chamber T, T′ respectively. In these chamber pairs a re-layering of the layers takes place which leads to the improvement of the mixing quality. A further mixing step takes place at the same time in the second re-layering chamber S2, S2.

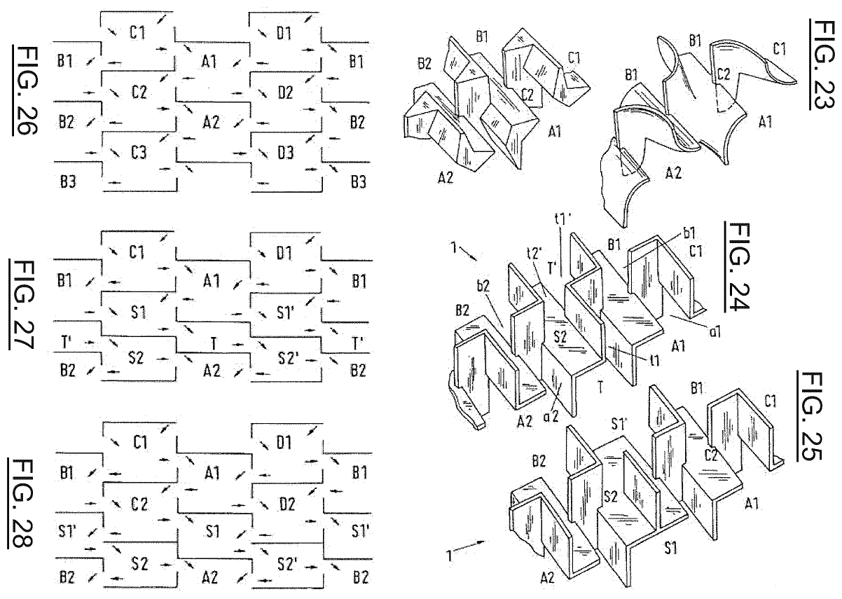

FIG. 25 shows a second embodiment of the mixer structure in which re-layering chambers S1, S2′ and S1′, S2, which are present pairwise, are directly adjacent. From the oblique views of FIGS. 21A, 24 and 25 the interconnection of the individual chambers is difficult to see or cannot be seen in its entirety. This interconnection can readily be made recognizable by unwrapping the mixer structures 1 along their extent into a plane. Such unwrappings are shown in FIGS. 26 to 28. The two lateral margins, which extend parallel to the z-axis, are respectively formed by the string B with the chambers B1, B2, B3, . . . in FIG. 26, by B1, T′, B2, . . . in FIG. 27 and by B1, S1′, B2, . . . in FIG. 28.

The meander-like lines in FIGS. 26 to 28 represent the outer wall edges of the mixer structures 1. The outer corners of the deflection plates 3, 3′ (FIG. 21A) are not marked; they each lie in the middle of the horizontal stretches of the meander-like lines. The flow of the mixing material is indicated by arrows: inclined arrows at the entry points of the chambers, horizontal arrows at the exit points. In FIG. 26 (cf. FIG. 21A) all chambers are equivalent; they are mixing-active chambers.

In FIG. 27 the chamber arrangements S1-T-S2′ and S1′-T′-S2 are particularly noteworthy (cf. FIG. 24). In FIG. 28 the chamber arrangements S1-S2′ and S1′-S2 are particularly noteworthy (cf. FIG. 24).

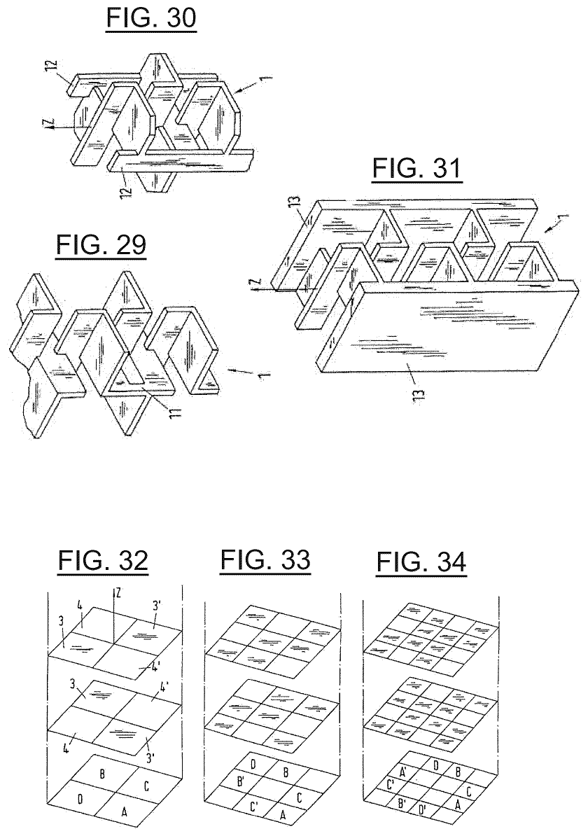

FIG. 29 shows a further preferable means.

It is as follows: most of the passages between adjacent mixing-active chambers are laterally bounded by the tube 10; for directing the flow, some individual passages are each bounded by a rib 11 arranged at the tube 10. Mixing material that flows along the tube wall is deflected into the interior of the tube 10 by these ribs 11. The mixing quality is thereby improved.

Since, as a rule, highly viscous media are treated by the mixer, large pressure gradients arise in the direction of the Z-axis of the mixer structure 1. These pressure gradients decrease when the wall thicknesses are made smaller. If the walls of the mixer structure 1 are thin, however, there is the danger that the structure will be crushed. The mixer structure 1 can be brought into a more stable form with suitable reinforcement means. FIGS. 30 and 31 show reinforcements by strips 12 and 13 which are arranged at the periphery of the mixer structure 1 in the Z-direction. Such reinforcements can naturally also be provided for mixer structures which contain no re-layering chambers.

FIGS. 21A to 31 relate to mixers whose mixing-active chambers are arranged in four strings. A mixer of this kind corresponds to the first exemplary embodiment which is described in the named U.S. application Ser. No. 08/660,434; it is shown again in FIG. 32 in the schematic form of representation chosen there. The two other exemplary embodiments are shown in FIGS. 33 and 34.

In FIG. 33 the two upper planes represent the boundaries between adjacent axial sections which have the mixing elements. Each of them has two open subsurfaces as well as two subsurfaces covered by deflection plates 3, 3′; and the open subsurfaces 4, 4′ are arranged to be mutually displaced. The lower plane specifies the designations A, B, C and D of the four chambered strings. Corresponding remarks hold for the mixers of FIGS. 33 and 34.

Mixers in accordance with FIG. 33 contain bundles with nine strings arranged in the direction of the tube, with six of these strings, namely A, C, B, D, B′ and C′, comprising mixing-active chambers and the remaining three strings, which are not designated, containing intermediate chambers which produce indirect connections between mixing-active chambers. The intermediate chambers arranged in the corner strings each have—like the above named transfer chambers T and T′—two passages to adjacent chambers. The intermediate chambers of the central string each contain four such passages, which are arranged in ring shape.

Mixers in accordance with FIG. 34 contain bundles with sixteen strings arranged in the direction of the tube, with eight of these strings, namely A, C, B, D, A′, B′, C′ and D′, comprising mixing-active chambers and the remaining eight strings containing intermediate chambers which produce indirect connections between mixing-active chambers. The intermediate chambers again each have two or four passages to adjacent chambers as in the embodiment of FIG. 33.

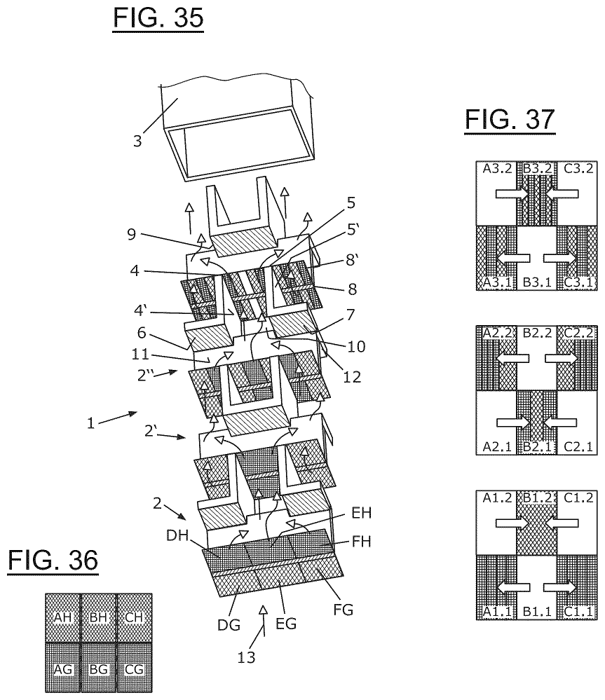

In the following, embodiments of a supplementary third aspect will be described with reference to the FIGS. 35 to 51:

FIG. 35 illustrates a detail of a first exemplary embodiment of a mixer 1 that comprises a number of identical mixing elements 2, 2′, and 2″, which are superimposed on one another while each successive element is rotated by 180° with respect to the longitudinal centre axis. Mixing enclosure 3 is schematically shown at one end.

Seen in the flow direction, i.e. from the bottom of the drawing, one end of each individual mixing element 2 comprises a transversal edge 8 of a transversal guide wall 8′ that is followed by two end sections 6 and 7 extending perpendicularly thereto and including complementary lateral openings 11 and 12, and by a bottom section 9 and a complementary bottom section opening 10, the latter extending between two guide walls 4′, 5′ each of which ends in a respective separating edge 4, 5, where the guide walls are aligned in parallel with the longitudinal centre axis. In the present example, the end sections extend over half the length of the separating edges. The openings, resp. their crosssectional areas, and the length of the webs essentially determine the pressure drop between the inlet and the outlet of the mixer.

The mixing element 2′ following mixing element 2 comprises the same components and structures, but it is superimposed on first mixing element 2 in a position rotated by 180° with respect to the longitudinal axis. The following mixing elements are also identical to mixing element 2 and arranged one after another while rotated by 180° each as seen in the longitudinal direction. The flow direction is indicated by arrow 13.

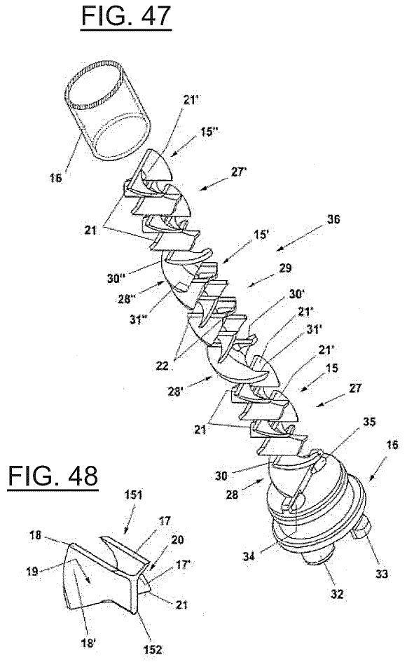

FIG. 36 indicates the distribution of the two components G and H at the mixer entrance, each component being supplied from a container of a double cartridge or a dispensing appliance having separate outlets, see FIG. 47. In the present example, according to the flow direction, the mixer entrance is shown at the bottom. After their entrance on either side of transversal edge 8, the components G and H spread along transversal guide wall 8′ and are divided into three streams by guide walls 4′, 5′, so that six streams AG, BG, CG and AH, BH, and CH are finally produced, to which respective chambers DG, EG, FG; DH, EH, FH can be associated in the mixer.

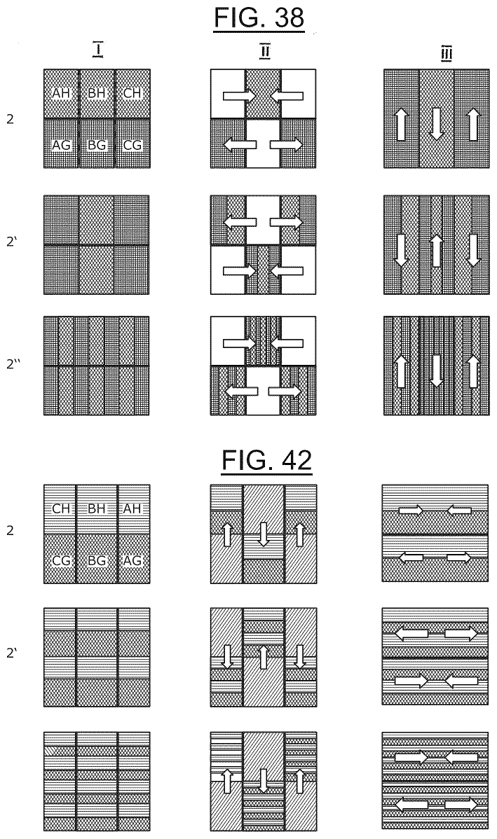

During further dispensing, the six streams reach the following mixing element 2′. In the process, on one side of the transversal edge, the mixed and spread streams AG, BG, and CG are displaced through lateral openings 11 and 12, and on the other side of the lateral edge, the spread streams AG, BH, GH are displaced through bottom opening 10, as indicated in FIG. 37 schematically. Thus, at the end of element 2, the mixed streams A1.G and C1.G with B1.G as well as A1.H and C1.H with B1.H=A1.1 and C1.1 with B1.1 and A1.2 and C1.2 with B1.2 are obtained according to the diagram of FIG. 37. After having reached the second mixing element 2′, the mixed streams spread on either side of the lateral edge.

Then, the mixed and spread streams A2.1, B2.1, and C2.1 are displaced outwards through lateral openings 11 and 12, and the mixed streams A2.2, B2.2, and C2.2 are displaced inwards through bottom opening 10, as follows from FIG. 37, whereupon these streams are spreading again.

In the next step, the displacement occurs in the other direction, i.e. streams A3.1, B3.1 and C3.1 are displaced inwards and A32, B 3 2 and C3.2 outwards, as shown in FIG. 37 as well. Again, when entering the following element, the components spread on both sides of the lateral edge and are subsequently displaced again to reach the following mixing element.

The arrangement and the construction of the mixing elements result in a three phase sequence of the mixing process, in which the composition is first divided, then spread and subsequently displaced, only to be divided, spread, and displaced again in the following step.

This is shown in the diagram of FIG. 38, in which the three steps of dividing. displacement and spreading are illustrated in three stages. In the diagram of FIG. 38, separating is symbolized by I, displacement by II, and spreading by III, while the three mixing elements resp. mixing stages are designated by 2, 2′, 2″. This diagram clearly shows that in mixing element 2, the two components G and H are first divided into two and subsequently into three respective streams, i.e. into six streams AG, BG, CG and AH, BH, GH, then on the one side three mixed streams are displaced through the two lateral openings as two streams and on the other side the three other mixed streams are displaced through bottom opening 10 to form a single stream, and then again to be spread as three mixed streams.

In an alternative embodiment for a larger mixer, more than two separating edges and guide walls can be provided, e.g. three separating edges and guide walls, which in the case of two components divide the material into more than six streams, while the bottom walls resp. openings are arranged in alternate directions resp. mutually offset. Also, as in the preceding example, a transversal edge is provided, so that the streams are divided into two portions. The result is an analogous configuration of a mixing element comprising more than one transversal edge and more than two separating walls.

Alternatively, it is also possible to operate the mixer in the reversed direction with respect to the flow direction, so that the material first reaches the separating edges rather than the transversal edge. Thus, the composition is first divided into three parts and then, during its passage through the two openings, into two parts. In this inverse flow direction, the two outer streams unite and spread on one half of the transversal edge while the two middle streams unite and spread on the other half of the transversal edge.

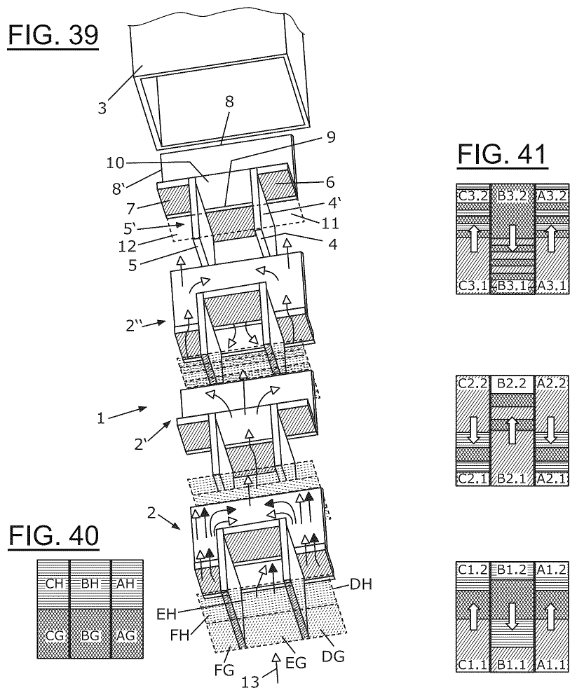

In FIGS. 39 to 42, mixer 1 is reversed by 180° with respect to FIG. 35 while the flow direction remains the same. For a better understanding, the individual components of the mixing element are listed again. At one end, seen from below in the direction of flow, the individual mixing element 2 comprises two separating edges 4 and 5 pertaining to respective guide walls 4′, 5′, which are aligned in parallel to the longitudinal center axis and comprise, perpendicularly thereto and on either side of the guide walls, two end sections 6 and 7 and a bottom section 9 situated between the guide walls and extending over half of the guide walls. Perpendicularly to the end sections, at the center of the guide walls, a transversal guide wall 8′ is arranged which comprises a transversal edge 8 at the other end of the mixing element.

The two end sections and the bottom section are complementarily associated with bottom section opening 10 between the guide walls and with the two lateral openings 11 and 12 on either side of the guide walls. The openings, resp. their cross-sectional areas, essentially determine the pressure drop between the inlet and the outlet of the mixer.

The mixing element 2′ following mixing element 2 comprises the same components and structures and is disposed on first mixing element 2 in a position rotated by 180° with respect to the longitudinal axis. Likewise, the following mixing elements are also arranged one after another in positions rotated by 180° each with respect to the longitudinal axis. The flow direction is indicated by arrow 13.

In FIG. 39, the distribution of the two components G and H at the mixer inlet is indicated, each component being supplied from a container of a double cartridge or a dispensing appliance having separate outlets, see FIG. 47. In the present example, according to the flow direction, the mixer inlet is shown at the bottom. When entering the first mixing element 2, the two components are divided by separating edges 4 and 5 into six streams AG, BG, CG and AH, BH, and CH.

During further dispensing, the six streams reach the following mixing element 2′. In the process, the respective pairs of streams A1.G and A1.H, B1.G and B1.H, and C1.G and C1.H=A1.1 and A1.2, B1.1 and B1.2, and C1.1 and C1.2 are mixed with one another according to FIG. 41 while due to the geometrical structure of mixing element 2, stream A1.1 displaces stream A1.2 to reach the following mixing
element through lateral opening 11, stream B1.2 displaces stream B1.1 to reach the following mixing element through bottom section opening 10, and stream C1.1 displaces stream C1.2 to reach the following mixing element through lateral opening 12. When they arrive at the second mixing element 2′, the mixed streams B2.1 and B2.2 spread on one side of transversal edge 8 on the entire half A2.1-B2.1-C2.1, and likewise, the two mixed streams A2.1, A2.2 and C2.1, C2.2 spread on the other side of transversal edge 8 on the half A2.2, B2.2, and C2.2 shown at the front of the Figure.

In the next step, a displacement in the other direction results, i.e. stream B2.1 displaces stream B2.2, stream A2.2 displaces stream A2.1, and stream C2.2 displaces C2.1, as appears in FIG. 37 as well. Again, when entering the following mixing element, the components spread on a respective half and are subsequently displaced again to reach the following mixing element.

Here also, the arrangement and construction of the mixing elements result in a three phased sequence of the mixing process in which the composition is first divided, then displaced and finally spread, only to be divided, displaced, and spread again in the following step.

This follows from the diagram of FIG. 42, in which the three steps of dividing. displacing, and spreading are illustrated in three stages. In the diagram of FIG. 42, separating is symbolized by I, displacing by II, and spreading by III, while the three mixing elements as well as the corresponding mixing stages are designated by 2, 2′, 2″. This diagram clearly shows that in mixing element 2, the two components are divided into six streams, then a respective stream displaces the other one to spread towards the second mixing element 2′ in such a manner that the central streams form one half on one side of transversal edge 8 and transversal guide wall 8′ while the two outer pairs of streams jointly form the other half on the other side of the transversal edge and the transversal guide wall.

The mixers described above not only provide an intimate mixing of the materials but first of all a lower pressure drop as well as reduced dead volumes as compared to other mixers mentioned in the introduction.

Based on this simplified discussion of the schematic mixing operations, the following variations are possible: In these exemplary embodiments, mixers having rectangular resp. square cross-sections have been described, and the two impinging components have the same cross-sectional area. However, this need not always be the case, but any cross-sectional, resp. volume stream ratio of the two components G and H can be chosen at the inlet section, e.g. between 1:1 and 1:10, whereby the dimensions of the mixing elements remain the same. It is however possible to envisage specially adapted mixing elements. This means that the transversal edge need not be arranged on the center line of the mixing element. The same applies to the distance between the separating edges and the guide walls.

Furthermore, the separating edges and guide walls can be arranged at a mutual angle, and likewise, the end sections and the bottom section as well as the transversal edge can be arranged at a mutual angle, so that the openings are not necessarily rectangular or square. Also, the edges, e.g. the transversal edge, can incorporate a bend. The mixing elements need not be arranged one after another in positions rotated by 180°, but any angle from 0° to 360° is possible.

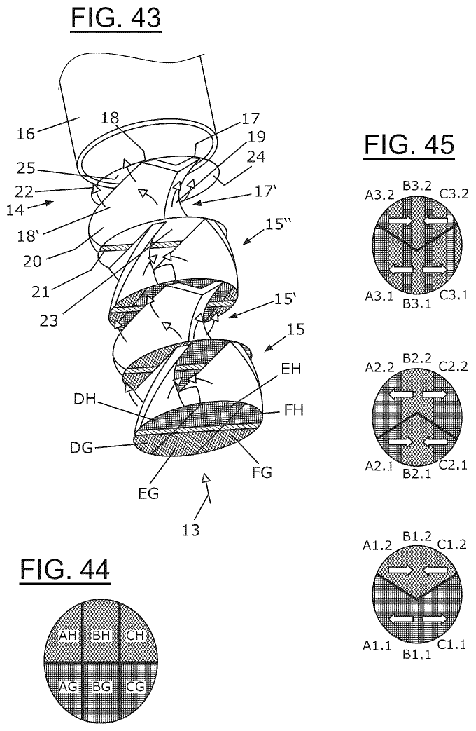

It is also possible to arrange the previously described mixing elements in an enclosure having a cross section other than rectangular, e.g. in a round, an orbicular, resp. cylindrical, a conical, or an elliptic enclosure.

Whereas the previously described mixing elements provide good mixing properties, the walls arranged at an angle still include dead volumes giving rise to cured material in spite of the improved design. A further reduction of the dead volume is provided by a mixer having mixing elements with curved walls. A mixer of this kind is represented in FIGS. 43 to 46.

FIG. 43 shows a mixer 14 with a regular cylindric housing as a particular case of a round mixer having mixing elements with curved walls, including mixing elements 15, 15′, and 15″ and enclosure 16. In analogy to the first mixer 1, at one of its ends, i.e. at the bottom as seen in the flow direction, mixing element 15 comprises a transversal edge 21 where two guide walls 17′, 18′ originate which end in respective separating edges 17, 18. The guide walls each comprise a respective end section 19 and 20 with lateral openings 24, 25, a bottom section 22, and a complementary bottom section opening 23.

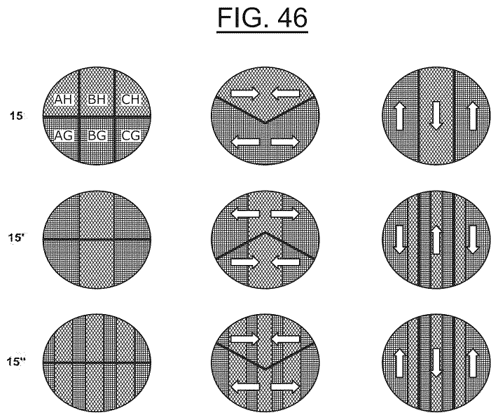

The individual sections are not as clearly demarcated here as in the first exemplary embodiment. In contrast to the rectangular mixing element 2, the two guide walls 17′, 18′ form a curved and continuous transition between separating edges 17 and 18 situated at one end thereof and transversal edge 21 at the other end. This curved configuration of the guide walls, resp. their transition to the transversal edge appears in FIG. 43, the schematized transition being shown in FIG. 46.

The operation of this second exemplary embodiment is the same as in the first example. In analogy to the latter, the material stream consisting of the two components G and H is divided into a total of six streams AG, BG, CG, AH, BH, and CH as it leaves the first mixing element 15.

In this example, the mixing operation is effected in analogy to the first exemplary embodiment, whereas the guide walls are no longer arranged in a sharp, rectangular disposition but run towards each other in a V-shaped configuration and have a curved shape. The mixing principle according to FIG. 45 is the same as in the first example, i.e. the central stream BG=B1.1 in FIG. 45 mixes with the two other streams AG=A1.1 in FIG. 45 and CG=C1.1 in FIG. 45 and is displaced through lateral openings 24, 25, and spreads while on the other side of the transversal edge, the two outer streams AH=A1.2 and CH=C1.2 mix with central stream BH=B1.2 are displaced through bottom section opening 23, and spread. Due to the curved construction and the V-shaped arrangement of the guide walls, dead volumes are substantially reduced, thereby resulting in reduced losses. On the other hand, this arrangement results in a further reduced pressure drop.

It is conceivable in this exemplary embodiment that the two guide walls 17′, 18′ are provided at the transition to transversal wall 21 with an additional web 152 disposed in the longitudinal axis and transversally to the transversal wall, which would theoretically divide the material into three rather than two parts at the exit near the transversal wall, see FIG. 48 illustrating a mixing element 151. However, such an additional web offers no advantages but rather the inconvenience that the material may not spread on that side. It is also possible to provide such a web in the first, rectangular mixer, i.e. below floor 9 and along transversal edge 8. However, the following considerations and the claims do not take account of this additional partition.

Also, the diagram of FIG. 46 will be interpreted in analogy to the diagram of FIG. 38 with the difference that the perpendicular guide walls 4, 5′ provided according to FIG. 38 are V-shaped here and end in the transversal edge.

In analogy to the first example, the cross-sectional, resp. volume stream ratios of the components G and H can be different from 1:1, and most importantly, the guide walls leading from the separating edges to the transversal edge can assume a multitude of geometrical shapes while the mixing elements can be reversed to the shown arrangement with regard to the flow direction. Also, the mixing principle is the same in each case, i.e. the central streams mix with each other and spread on one side of the transversal edge, and then the two outer pairs of streams spread on the respective other side of the transversal edge. Furthermore, the successive mixing elements need not necessarily be rotated by 180° each with respect to the longitudinal axis as shown in FIG. 43 but can be disposed in any orientation.

In the exemplary embodiment of FIG. 47, a novel mixer arrangement is shown which achieves particularly good results with the described mixing elements. FIG. 47 shows a mixer 36, mixer enclosure 16 and the mixer entrance with inlets 32 and 33 and outlet openings 34 and 35. As in the mixers of the prior art using mixing helixes, entrance edge 31 of the first helix mixing element 28 extends transversally across the two outlet openings 34, 35. The two separating edges of first mixing element 15 of first mixing group 27 are disposed transversally to outlet edge 30 of the first helix mixing element. The first mixing group 27 consists of the mixing elements 15, of which four are illustrated here by way of example. This group is followed by the second helix mixing element 28′, which in turn is followed by a second mixing group 27′. This second mixing group also consists of four mixing elements 15′, which however are reversed by 180° in the direction of flow against the first mixing group, i.e. with the transversal wall directed towards the inlet, whereby this group has a similar effect as that of FIG. 43.

Furthermore, it follows from FIG. 47 that transversal edge 21 of the last mixing element of each mixing group is perpendicular to entrance edge 31′ of mixing helix element 28′. The periodical insertion of a mixing helix element serves the purpose of efficiently peeling the material from the walls and of re-layering it, thereby providing a further improvement of the mixing efficiency.

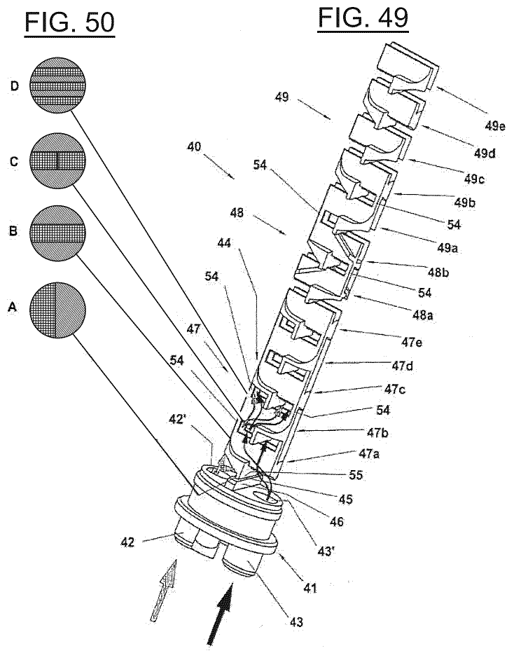

In FIG. 47, three mixing groups and three mixing helix elements are shown, but it is understood that the number of mixing groups and mixing elements can vary according to the intended purpose. Thus, both the number of mixing elements per mixing group and the number of mixing helix elements between the mixing groups can vary. All considerations concerning the mixing operation and the application of conventional mixing helixes also apply for the homogenization of materials and for mixing arrangements using mixing elements according to FIG. 49.

The exemplary embodiment of FIGS. 49 to 51 is based upon the exemplary embodiment of FIG. 35 with straight element walls, the mixing elements however being arranged in a regular cylindrical housing. In this exemplary embodiment, several features are indicated which provide both an improvement of the mixing action and a reduction of the dead volumes resp. of the losses associated therewith, and thus allow a substantially increased overall efficiency. It is understood that not all of these features need be provided in all mixing elements or mixing groups at the same time.

FIG. 49 shows a mixing element arrangement 40, whereby the housing is not shown, including inlet portion 41 with inlets 42, 43 and outlets 42′, 43′ as well as mixing section 44 with the mixing elements. Up to the first transversal edge 45, the components are separated by a separating wall 46. In this exemplary embodiment, five mixing elements 47a-47e are integrated in a first mixing group 47, while the second mixing group 48 comprises two mixing elements 48a and 48b and the following mixing group 49 again includes five mixing elements 49a-49e.

Using the mixer according to FIG. 35, 49 or 51 it can be advantageous to provide that the height ZL of guide walls 50, 51, which are reached by the material after the transversal guide wall, is greater than the height ZQ of the transversal guide walls, e.g. by a preferred factor comprised between 1.1 and 2.0, more particularly 1.5. This lengthening of the double guide walls provides an improved alignment of the material, which is thereby allowed more time to spread before being divided again. Furthermore, the lengthening of the double guide walls results in a reduction of the number of mixing elements required to achieve an equal or better mixing quality.

In analogy, when using the mixer according to FIG. 39 in the reversed flow direction it can be advantageous to provide for a greater height ZQ of the transversal guide wall, reached after the guide walls by the material, than the height ZL of the guide walls, also with a preferred ratio of 1.1 to 2.0, in particular 1.5.

A second feature common to all mixing elements are measures for reducing the dead zones, which are particularly important in the case of straight walls and cause volume losses and local curing of the material. To this end, such dead zones are filled in. Different dead zone obturations TZV are indicated especially in FIG. 51. Thus, bottom section 9 comprises dead zone obturations TZV1 of a first type that are directed towards the preceding mixing element. The mixing elements having no inclined webs, i.e. mixing elements 47a-47e and 49a-49e, also comprise dead zone obturations TZV2 on the inwardly facing sides of the bottom sections. On the outside of guide walls 50 and 51 a third and fourth type of dead zone obturations TZV3 and TZV4 are provided in those locations where no inclined webs are present.

At straight walls, wall layers are formed that cause layer defects during layer formation. For the detachment of such layers, for the promotion of the longitudinal mixing action in the direction of the double guide walls, and for equalizing the concentrations, inclined webs are provided on the inside and on the outside of the guide walls.

In the mixer of FIGS. 49 and 51, these inclined webs are attached to the central mixing group 48 where internal inclined webs 52 and external inclined webs 53 are visible, both of which are attached to guide walls 50 and 51 of mixing elements 4851 and 48b.

Wall layers appear not only on the guide walls but also on the inner wall of the mixer enclosure. To optimize the layer formation, longitudinal webs are provided which connect the double guide walls on the outside. The longitudinal webs need not be provided in all mixing groups. In the exemplary embodiment of FIGS. 49 and 51, the longitudinal webs 54 are attached to the first and second mixing groups 47, 48, but they might as well be attached to the third or to any other mixing group, or alternatively in the same way as in mixing group 48.

The suggested measures resp. features are preferably used jointly, but embodiments where only some of the measures are applied are conceivable too.

The flow diagram of the mixing operation is shown in FIG. 50.

At A, the two components spread on the respective side of transversal guide wall 55. At B, the portion on the right side moves towards the center and spreads over the entire length of guide walls 50, 51 while the portion on the left side divides into two halves and forms the outer two thirds. At C, these three streams are divided transversally. At D, the left half is guided towards the center and spreads over the entire length of the guide walls while the portion on the right side is divided and the halves reach respective sides of the guide walls, whereupon a transversal edge follows again, etc.

The main features are applicable in the simplified case where the transversal edges and guide walls do not comprise any webs as web 152, which do not change the general mixing principle of the mixing elements. Moreover, the definition of a transversal wall includes a possible duplication of the transversal edge into two parallel transversal walls as this does not change the mixing principle either.

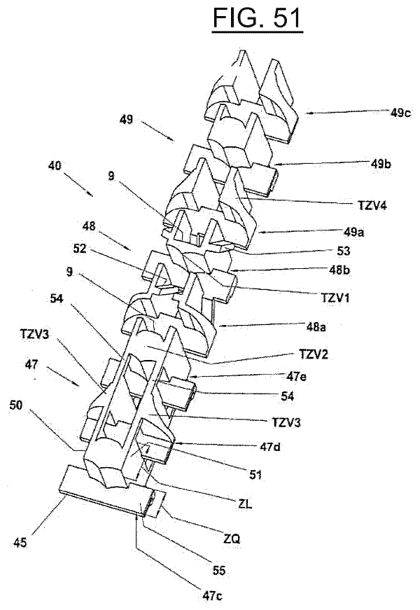

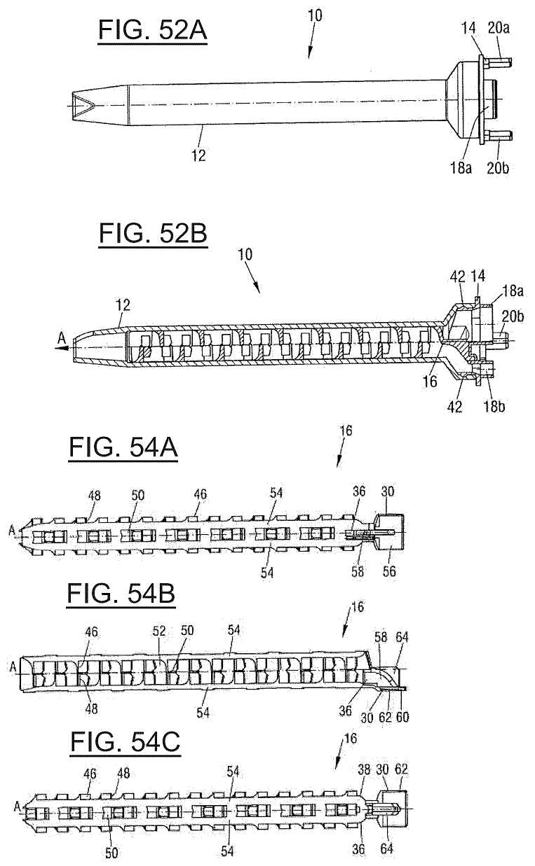

In the following, embodiments of a supplementary fourth aspect will be described with reference to the FIGS. 52A to 61B:

In the following the same reference numerals will be used for parts having the same or equivalent function. Any statements made having regard to the direction of a component are made relative to the position shown in the drawing and can naturally vary in the actual position of application.

FIG. 52A shows a side view of a first type of static mixer 10 having a first type of mixer housing 12. The mixing element 16 (see FIG. 52A) and part of the mixer inlet section 14 (see FIG. 52B) are arranged within the mixer housing 12. One inlet 18a into the mixer inlet section 14 can be seen, as can alignment means 20a, 20b by which the mixer inlet section 14 is aligned relative to a cartridge 100 (see FIG. 60).

FIG. 52B shows a section through the static mixer 10 of FIG. 52A when the static mixer 10 is rotated by 90° about the longitudinal axis A. Both of the inlets 18a, 18b into the mixer inlet section 14 can be seen in this position. Furthermore, the mixing element 16 is arranged within the mixer housing 12.

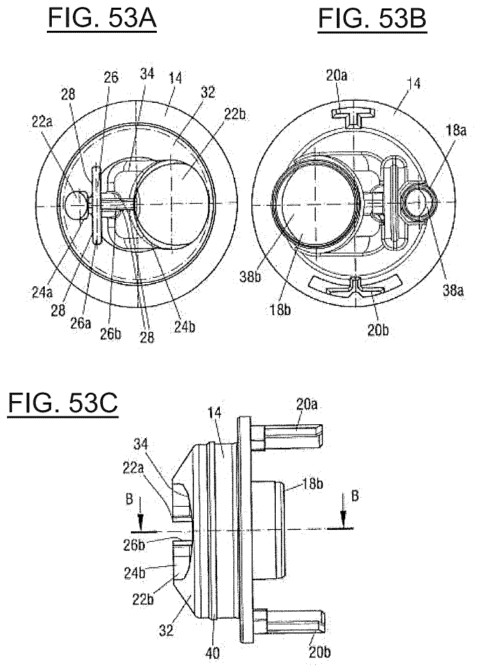

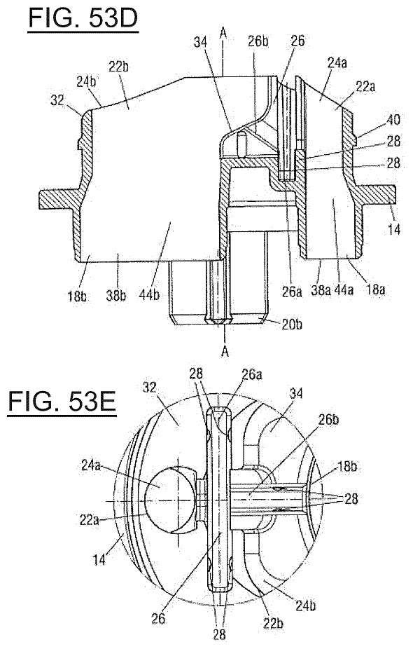

FIGS. 53A-53E shows various views of the mixer inlet section 14 of FIGS. 52A and 52B. FIG. 53A shows a top view of the mixer inlet section 14. The mixer inlet section 14 has a generally circular shape in the top view. The mixer inlet section 14 has two outlets 22a, 22b each having an outlet opening 24a, 24b. A counter plug element 26 is arranged between the outlets 22a, 22b. In the present example the counter plug element 26 is configured as a socket.

The counter plug element of FIG. 53A is formed by a first groove 26a and a second groove 26b extending transverse thereto. Noses 28 are disposed within the first and second grooves 26a, 26b. The noses 28 are adapted to cooperate with a plug element 30 (see FIGS. 54A-54C) such that they frictionally engage the plug element 30 to fix the plug element 30 relative to the counter plug element 26.

The counter plug element 26 is configured such that the plug element 30 can only be inserted in one direction into the mixer inlet section 14. Thereby the shape of the counter plug element 26 acts as coding means for the insertion of the generally T-shaped end of the plug element 30.

The outlet openings 24a, 24b are respectively formed in an output surface 32 of the mixer inlet section 14. Adjacent to the outlet opening 24b a recess 34 is formed within the outlet 22b. The recess 34 expands a volume of the outlet 22b relative to the inlet 18b.

The recess 34 has an elongate shape and thereby enlarges and directs a flow path of a component 102b (see FIGS. 61A and 61B), flowing from the inlet 18b to the outlet 22b. The recess 34 thereby acts as a guide reservoir for the component 102b that flows into the mixing element 16.

The guide reservoir enables the component 102b to be directed into inlets 36 (see FIGS. 54A to 54C) of the mixing element 16, so that an ideal point of entry for the component 102b into the inlets 36 can be selected.

In order to improve the introduction of the components 102a, 102b into the mixing element 16, the outlets 22a, 22b of the mixer inlet section 14 are spaced less far apart than the corresponding inlets 18a, 18b.

The outlet opening 24a is approximately a tenth of the size of the outlet opening 24b. This is because the mixer inlet section 14 is used for multi-components having a medium to high mixing ratio such as 4:1 and 10:1, this means that one of the components is introduced into the mixing element at a ratio of 4:1 or 10:1 with respect to the other component.

FIG. 53B shows a bottom view of the mixer inlet section 14. The inlets 18a, 18b have a substantially circular shaped inlet opening 38a, 38b. The shape of the inlet opening is selected so that the inlets 18a, 18b can be connected to outlets of a cartridge 100 (see FIGS. 61A and 61B).

The inlets 18a, 18b are in fluid communication with the respective outlets 22a, 22b, so as to guide components from the cartridge 100 to the mixing element 16.

The alignment means 20a, 20b are used in order to align the mixer inlet section 14 with the cartridge 100. In order to connect the mixer inlet section 14 of the static mixer 10 to the cartridge 100 in a coded and aligned manner the alignment means 20a, 20b have a different size so that these can only be positioned in one way. Moreover, the alignment means 20a, 20b have a generally T-shaped cross-section for this purpose. Attachment means (not shown) such as a retainer nut can additionally be used to, at least intermittently fixedly, connect the static mixer 10 to the cartridge 100.

Having regard to the high ratio mixer inlet section, the inlets 18a, 18b are also of different size so that these can only be placed on to the cartridge 100 in one way and thereby also act as coded alignment means.

FIG. 53C shows a side view of the mixer inlet section 14 of FIG. 53A. The outlets 22a, 22b of the mixer inlet section 14 are connected to one another via a volume forming at least a part of the counter plug element 26. Once the plug element 30 cooperates with the counter plug element 26, the outlets 22a, 22b are separated from one another by the plug element 30 (see FIGS. 55A and 55B).

Moreover, one can see a side view of the generally T-shaped alignment means 20a, 20b in FIG. 53C.

The mixer inlet section 14 has a projection 40 arranged adjacent to the output surface 32. This projection is adapted to cooperate with a groove 42 (see FIG. 52B) arranged in the mixer housing 12 in order to latch the mixer housing 12 to the mixer inlet section 14.

FIG. 53D shows a section through the mixer inlet section 14 along the sectional line 8-8 of FIG. 53C. The outlet 22b is arranged such that at least a part of the outlet opening 24b is arranged around the longitudinal axis A of the static mixer. Thereby the component is guided from the inlet 18b to the mixing element 16.

One can see how the flow path 44b between the inlet 18b and the outlet 22b is directed towards the longitudinal axis A. Through the provision of the recess 34, the diameter of the flow path 44b (the same is true in analogy for the flow path 44a) experiences no constrictions in the region of the outlet 22b. This is because a distance between the mixer housing 12 and the recess 34 is selected such that the diameter of the flow path 44b is kept at least substantially equal throughout the mixer inlet section 14 and up to the mixing element 16. For this reason, the flow of the component 102b experiences significantly less flow resistance on its passage through the mixer inlet section 14 up to the mixing element 16 on being discharged from the cartridge 100 in comparison to prior art static mixers (not shown). Likewise, the flow path 44a between the inlet 18a and the outlet 18 b is shifted towards the longitudinal axis A.

FIG. 53E shows an enlarged view of the generally T-shaped counter plug element 26. The outlets 22a and 22b are connected to one another via the counter plug element 26. The connection is closed once the plug element 30 is inserted into the counter plug element 26 (see FIGS. 55A and 55B). Furthermore, four noses 28 are visible in the region of the first groove 26a. The four noses 28 are configured to engage the corresponding plug element 30.

FIGS. 54A to 54C show various views of a first type of mixing element 16. The mixing element 16 comprises mixer elements 46 for separating the material to be mixed into a plurality of streams, as well as means for the layered merging of the same. The means comprise transverse edges 48 and guide walls 50 that extend at an angle to the transverse edges 48, as well as guide elements 52 arranged at an angle to the longitudinal axis A and provided with openings.

The individual mixer elements 46 are connected to one another by struts 54, with the struts 54 also acting as further guide and deflecting walls. The number of mixer elements 46 and the corresponding length of the struts 54 is selected in dependence on the kind of material that is to be dispensed with a certain static mixer 10. For some applications five mixer elements 46 can be sufficient whereas for others ten or more mixer elements 46 can need to be connected to one another by struts 54.

FIG. 54A shows a side view onto the mixing element 16. At the right hand side of the mixing element 16, there is a plug element 30. This is composed of a wall section 56. Some of the wall section 56 has a U-shaped cross-section that leads into a T-shaped cross-section. A groove 58 is formed in the wall section 56 that extends from the T-shaped cross-section through the U-shaped cross-section and towards an inlet 36 of the mixing element 16.

FIG. 54B indicates how this groove extends from a surface 60 of the plug element 30 towards the inlet 36 of the mixing element 16. The groove thereby extends the flow path 44a from the mixer inlet section 14 into the mixing element 16 (see also FIGS. 55A and 55B in this regard).

FIG. 54C like FIG. 54B shows how the T-shaped wall section 56 is formed by a first wall 62 and a second wall 64 extending transverse thereto. The groove 58 is formed extending from the surface 60 within the second wall 64 towards the inlet 36 of the mixing element 16.

FIGS. 55A and 55B show perspective part views of the first type of static mixer 10. In particular one can see how the flow path 44a extends from the inlet 18a of the mixer inlet section 14 via the outlet 22a and the groove 58 towards one of the inlets 36 of the mixing element 16.

Likewise, the flow path 44b extends from the inlet 18b via the outlet 22b of the mixer inlet section towards inlets 36 of the mixing element 16. The flow path 44a is smaller in diameter than the flow path 44b, as the mixer inlet section 14 and the mixing element 16 currently employed are used for high mixing ratios of e.g. 4:1 and 10:1.

Moreover, the section shown in FIG. 55A indicates how the flow path 44b is enlarged in the region of the outlet 22b in comparison to the inlet 18b. This enlargement of the flow path 44b is further highlighted in FIG. 55B where one can see how the flow path 44b extends around the second wall 64 up to the first wall 62 of the wall section 56 of the mixing element 16. The flow path 44b is extended such that it comes into contact with substantially the whole width of the mixing element 16 in the region of the inlets 36 where it extends around the second wall 64. The region of the outlet 22b is arranged such that the component 102b flowing through the flow path 44b arrives in a directed manner at the inlet 36 of the mixing element 16.

Both FIGS. 55A and 55B show that the flow paths 44a, 44b are shifted with respect to the longitudinal axis A from the inlets 18a, 18b towards the longitudinal axis A in the regions of the outlets 22a, 22b. Thereby the components 102a, 102b flow into the mixing element 16 in a more directed manner and can be introduced into the mixing element 16 in an optimum way, so that a mixing result is improved. This also leads to a reduction in the length of the mixing element 16 and hence to a reduction in the residual volume remaining in the static mixer 10.

Moreover, the shift of the flow paths 44a, 44b takes place within the mixer inlet section 14, so that a spacing between the mixer inlet section 14 and the mixing element 16 can be reduced leading to a further reduction in the residual volume remaining in the static mixer 10. This is advantageously achieved in a mixer inlet section 14 having the same height as prior art mixer inlet sections (not shown).

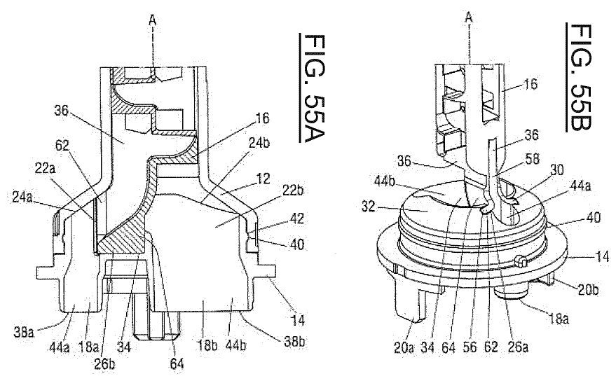

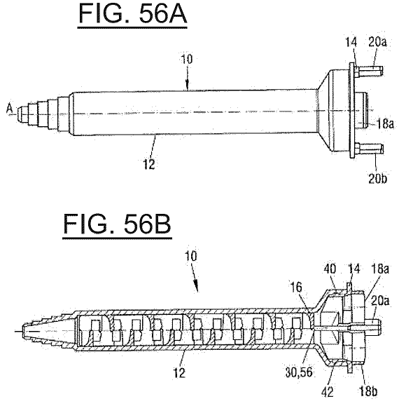

FIGS. 56A and 56B show a second type of static mixer 10 in a second type of mixer housing 12. The mixer is typically used for low ratio mixing of components such as 1:1 or 2:1.

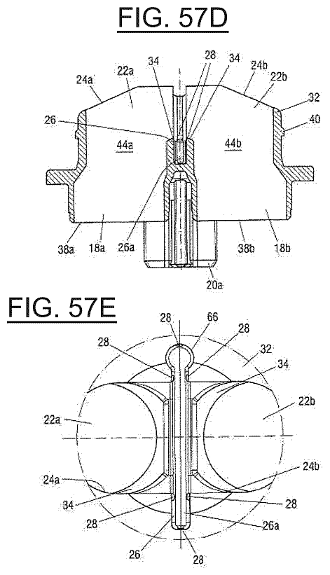

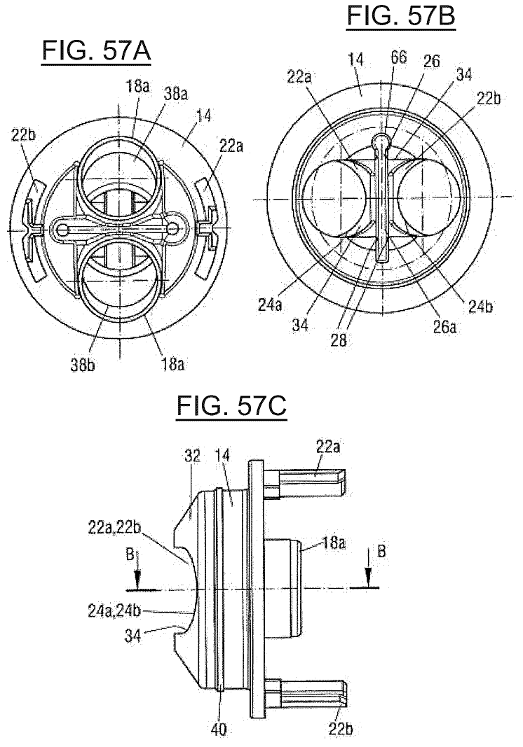

FIGS. 57A-57E show a second type of mixer inlet section 14 designed for 1:1 and 2:1 mixing ratios. FIG. 57A shows a bottom view of the mixer inlet section 14 in which the inlets 18a, 18b and the corresponding inlet openings 38a, 38b are of equal size.

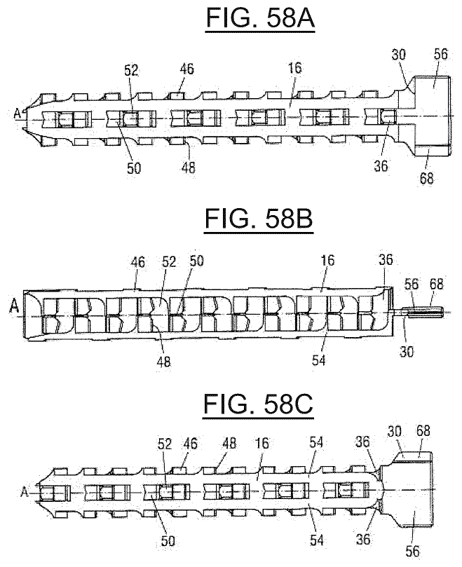

FIG. 57B shows a top view of the mixer inlet section 14 in which the outlets 22a, 22b and the corresponding outlet openings 24a, 24b are of equal size. A counter plug element 26 having only a first groove 26a extends between the outlets 22a, 22b. A recess 66 is arranged at an end of the first groove 26a. This recess 66 is adapted to cooperate with a bulge 68 (see FIGS. 58A-58E) configured at the plug element 30 of the mixing element 16.

As the outlets 22a, 22b have the same size, the side view of FIG. 57C appears to have a continuous outlet opening 24a, 24b. As can be seen from FIG. 57D this is because the mixer inlet section 14 has a free space extending into the recess 34 and adjacent to the first groove 26a into which free space the plug element 30 of the mixing element 16 is inserted to separate the outlets 22a, 22b from one another so that a mixing of components only takes place once the components enter the mixer elements 46 of the mixing elements 16.

Like with the outlet 22b of FIGS. 53A-53E, both of the outlets 22a, 22b have a recess 34 adjacent to the output surface 32. This recess 34 expands a volume of the respective outlet 22a, 22b in an elongate way to form a component flow guide region adjacent to the output surface 32. The component flow guide region acts as a region in which the components 102a, 102b can flow into the inlets 36 of the mixing element 16 in a directed manner. In order to complement the directed flow of the components a shape of an inlet surface of the mixer housing 12 is adapted to the shape of the output surface 32 of the mixer inlet section 14. In the present example the output surface 32 has a part spherical shape.

As can be seen in the section of FIG. 57D, the inlets 18a, 18b start merging into the outlets 22a, 22b at approximately a third of the length between the inlet openings 38a, 38b and a top most part of the outlet openings 24a, 24b. The outlets start at approximately two third of a length between the inlet openings 38a, 38b and a top most part of the outlet openings 24a, 24b. The same is true for the example shown in FIGS. 53A-53E.

FIG. 47e shows an enlarged view of the region of the first groove 26a. A nose 28 is visible within the recess 66. This, like the other noses 28 configured in the first groove 26a, is designed to frictionally engage the wall section 56 of the plug element 30 when the plug element 30 cooperates with the counter plug element 26.

FIGS. 58a to 58c show perspective views of a second type of mixing element 16. The mixer elements 46 of the mixing element 14 are configured like the embodiment shown in FIGS. 54a to 54c. The difference is to be seen in the wall section 56 of the plug element 30.

The wall section 56 shown in the side view of FIG. 58a has a generally planar shape with a bulge 68 configured at an end thereof. The bulge 68 is configured so that it extends substantially in parallel with the longitudinal axis A.

FIG. 58b shows a further side view when the mixing element 14 is rotated by 90° about the longitudinal axis A. One can see how the wall section 56 has a thinner diameter in comparison to the bulge 68.

FIG. 58c shows a further rotation of the mixing element 14 by 90° about the longitudinal axis A. Now the bulge 68 is positioned at the top of the wall section 56 of the plug element 30. The bulge 68 is a coded alignment means, so that the plug element 30 can only be plugged into the counter plug element 26 of the mixer inlet section 14 of FIGS. 57A-57E in one way.

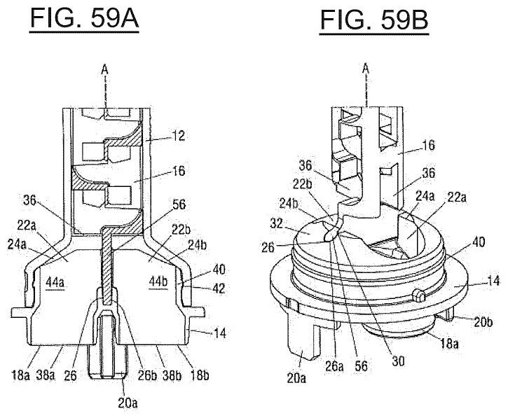

FIGS. 59A and 59B show perspective part views of the second type of static mixer 10. Both flow paths 44a, 44b are directed from the inlets of the mixer inlet section 14 to the inlets 36 of the mixing element 16. Thereby a geometric center of the outlet openings 24a, 24b is spaced less far from the longitudinal axis A than a geometric center of the inlet openings 38a, 38b to direct the flow path 44a, 44b of the components 102a, 102b towards the inlets 38.

FIG. 60 shows a dispensing apparatus 98 comprising a multi-component cartridge 100 and a static mixer 10. The multi-component cartridge 100 is filled with respective components 102a, 102b. The components 102a, 102b can be discharged from the cartridge 100 by a plunger (not shown) into the inlets 18a, 18b of the mixer inlet section 14 of the static mixer 10. The static mixer 10 is connected to the cartridge 100, on the one hand, by the alignment means 20a, 20b for a coded alignment between the static mixer 10 and the cartridge 100. On the other hand, the static mixer 10 is connected to the cartridge 100 by a retainer nut (not shown). The retainer nut is adapted to cooperate with the cartridge 100 and engages the mixer housing 12 of the static mixer 10 in order to fix the static mixer 10 to the cartridge 100.

FIG. 61A shows a schematic sectional view of a molding device Ma for a mixing element 16 as described herein. FIG. 61B shows a sectional view of a molding device Mb for a mixer inlet section 14 as described herein. The molding devices have respective inputs for the components to be injected (not shown) and for any required vacuum apparatus (also not shown). In order to mold the specific components, inserts specific for any shapes of the components are also introduced into the molding devices Ma, Mb.

Using the molding devices Ma, Mb mixer inlet sections 14 and mixing elements 16 as described herein can be produced.

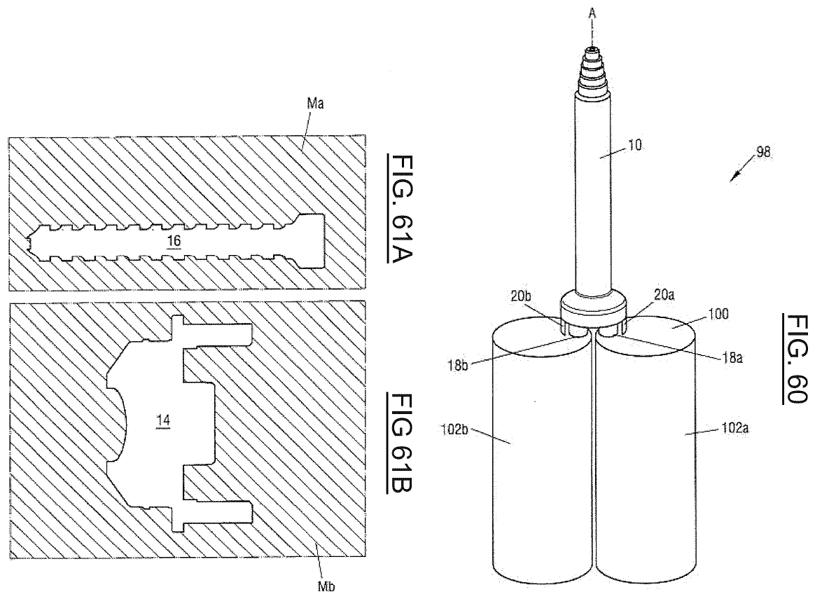

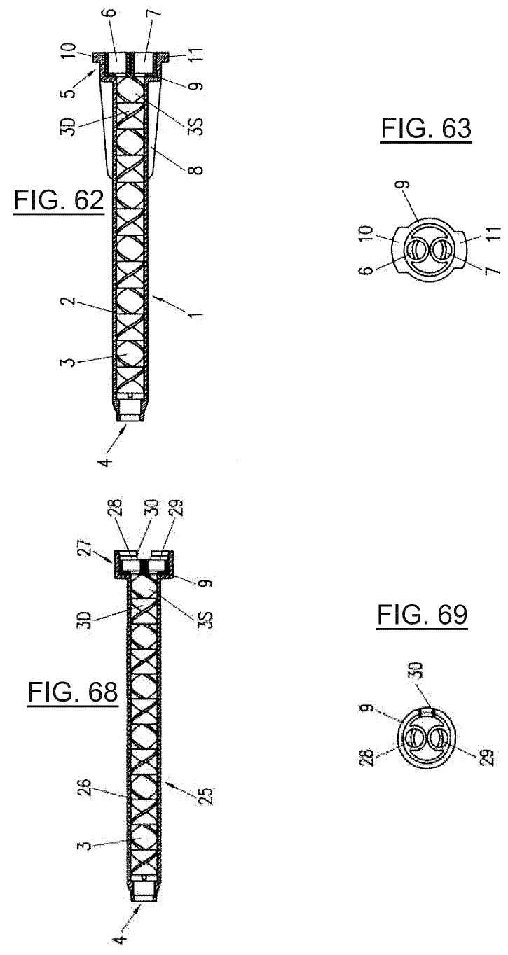

In the following, embodiments of a supplementary fifth aspect will be described with reference to the FIGS. 62 to 119:

FIGS. 62 and 63 show a mixer 1 comprising a mixer housing 2, a mixer element group 3, the mixer outlet 4 and a mixer inlet section 5 with two separated inlet parts 6 and 7, which are integral with a properly aligned separating element 3S of the mixer element group 3. This mixer is attached to the cartridge by matching the mixer different width bayonet lugs 10, 11 to the different width bayonet sockets 19, 20 while pressing the mixer onto the cartridge and by rotating the mixer housing 2. The separated inlet parts 6 and 7 and the mixer element group 3 with the separating element 3S do not rotate. Separating element 3S serving in this embodiment as a separating means for guiding each chemical component separatedly to the first dividing element 3D of the mixer element group 3.

The mixer housing is provided with longitudinal ribs 8 that end at the larger diameter 9 of the mixer housing 2. The two lateral ends of the ribs are formed as bayonet lugs 10 and 11 cooperating with the bayonet retaining the cartridge. As follows from FIG. 63, the two lugs do not have the same width, lug 10 being larger than lug 11. As will be shown later, the different width of the lugs enable a coded alignment and attachment of the mixer to the cartridge.

The mixer element group 3 is connected to the separated inlet parts 6 and 7 and is disposed in such a way within the housing that the housing itself is rotatable around the mixer element group 3 with attached inlet parts 6 and 7, which are
arranged at the inlet side of the first mixer element 3S serving in this embodiment as a separating means for guiding each component separately to the first dividing
element 3D of the mixer element group 3.

In FIG. 64, the cartridge 12 comprises two cylindrical containers or chamber 13 of equal cross-sectional areas for a 1:1 metering ratio ending in two individual, separate cylindrical and distal outlets 14 and 15. The outside shapes of the distal outlets 14 and 15 of the cartridge correspond to the respective inside shapes of the separate inlets 6 and 7 of the mixer, (see FIG. 62), whereby the inlets of the mixer fit over the outlets of the cartridge for tightly sealed connections. A reverse arrangement, where the inlet parts 6 and 7 fit into the outlet openings 14 and 15 is also possible.

In FIG. 65, the bayonet means 16 at the cartridge comprises a ring-shaped bayonet socket 17 with two internal recesses 18 and a circular opening with two diametrically opposed different width bayonet cutouts 19 and 20 for receiving the corresponding different width bayonet lugs 10 and 11, (see FIG. 62), of the mixer, allowing coded introduction of the mixer in one predetermined position only. The flange parts 21 adjacent to the cutouts serve as bayonet retaining means for securing the lugs of the mixer.

The ring-shaped bayonet means provides, in particular, for increased strength of the bayonet retaining means and increased structural rigidity of the outlet end of the cartridge when, during dispensing, the hydraulic forces transmitted from the attached mixer are at a maximum. This arrangement is a substantial improvement in comparison with the prior art bayonet prongs.

FIGS. 66 and 67 show a variant to the embodiment shown in FIGS. 62 to 65 in that the containers 22 and 23 of cartridge 24 have different cross-sectional areas for metering ratios other than 1:1.

In both described cases, in order to attach the mixer to the cartridge, the mixer can only be aligned with its bayonet lug widths corresponding to the different width cutouts of the bayonet sockets, then pressed onto the cartridge such that when the mixer is in place and the outlets and inlets are connected, the mixer housing 2 is rotated by 90° for the engagement of the bayonet lugs 10, 11 in the bayonet retaining means 21 of the cartridge. This attachment method prevents contamination of one component by the other at the mixer-cartridge interface yet enabling a quick coded attachment of the mixer.

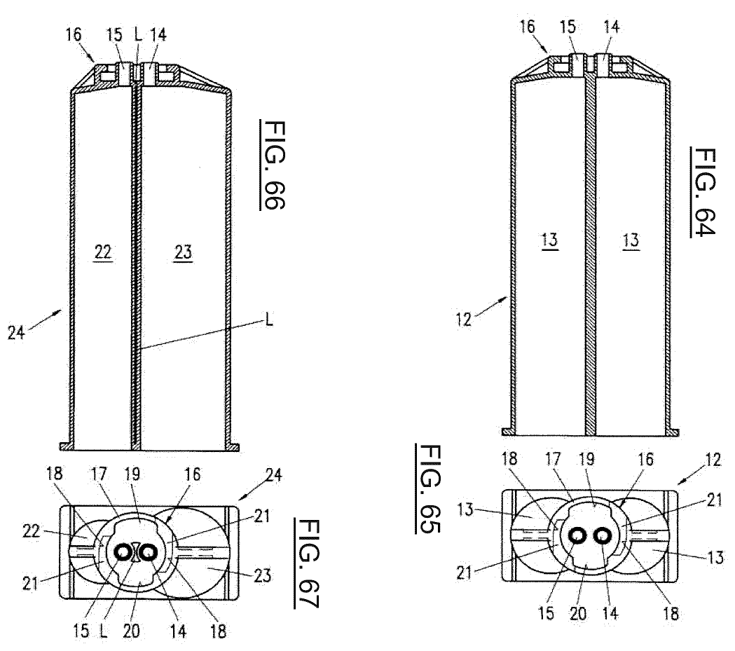

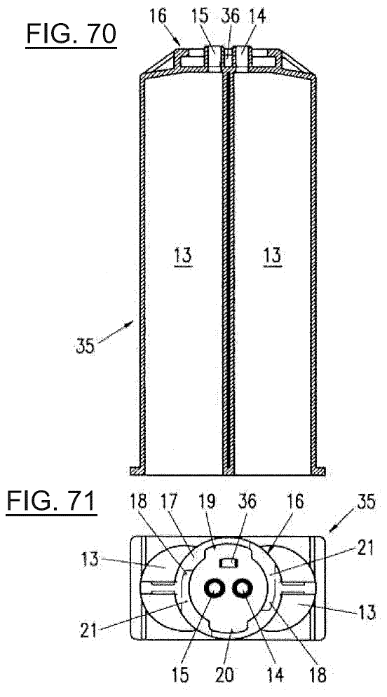

FIGS. 68 and 69 show in a second embodiment a mixer 25 comprising a mixer housing 26, a mixer element group 3, a mixer outlet 4, and a mixer inlet section 27. This mixer is fixed to the cartridge (see FIG. 70) with the aid of a separate coupling ring (see FIGS. 72 and 73). The coupling ring 31 is provided with two bayonet lugs 32 and 33 corresponding to the bayonet cutouts 19, 20, respectively of the bayonet attachment means 16 at the cartridge. For better manual gripping, ribs 34 are provided on the outer cylindrical surface.

It follows in particular from FIG. 68 that the mixer inlet section 27 comprises two cylindrical, individual inlet openings 28, 29 at the inlet side face of the first mixer element 3S serving in this embodiment as a separating means for guiding each component separately to the first dividing element 3D of the mixer element group 3. A slot 30 provides for a coded alignment of the mixer in regard to a cartridge.

Cartridge 35 (see FIGS. 70 and 71) is the same as cartridge 1 of FIG. 62 with the exception that the bottom of the bayonet attachment means 16 comprises a nose piece 36 corresponding to the slot 30 at the mixer (see FIGS. 7 and 8) for coded alignment of the mixer.

When connecting the mixer to the cartridge, the nose piece 36 on the cartridge fits into slot 30 of the mixer inlet section 27. This coded connection method assures not only one alignment possibility but also axial mixer attachment without rotation of the mixer housing, thus preventing contamination of one component by the other at the cartridge/mixer interface.

There are other coding means possible at the dispensing apparatus or cartridge and at the accessory for the coded alignment of the accessory to the dispensing apparatus or cartridge, e.g. pins or protruding parts of all kind fitting into a recess or cavity or slot.

FIG. 74 shows a mixer 38 attached to a cartridge 75 having containers 76 and 77 with different cross-sectional areas, as a variant to the embodiment shown in FIGS. 66 to 73 in that the mixer inlet section 37 of mixer 38 has a separating means within the mixer, which separating means comprises separated inlet chambers 39, 40, respectively having different cross-sectional areas, and lodged within a smaller combined diameter than the cartridge outlet with corresponding openings for each chamber for material to pass through.

The aforementioned separating means serves to maintain separation of the material flows up to the first dividing element 3D of the mixer element group 3. This separating means can have chambers with equal cross-sectional areas or have a cross-sectional area ratio other than 1:1. For example, the ratio of the cross-sectional areas of the separating chambers can be adapted to the cross-sectional areas of the containers 76 and 77 of cartridge 75, respectively to its metering ratio. The separating means is fixedly connected to the mixer element group 3.

The cartridge 75 has the same attaching means as in FIGS. 66 and 67, and the mixer 38 is attached to the cartridge by the coupling ring 31.

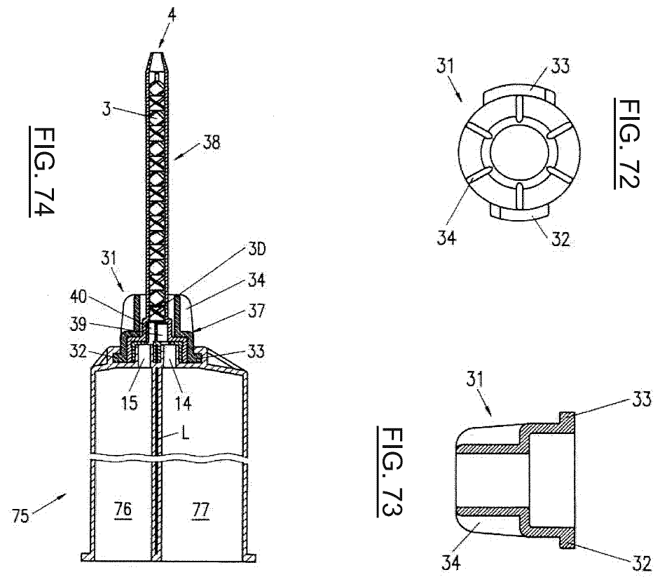

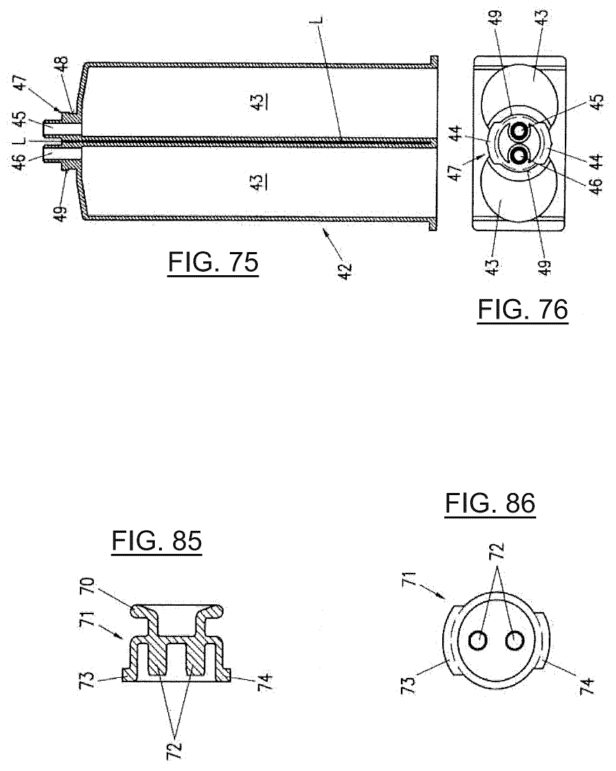

The embodiment according to the FIGS. 75 to 80 comprises a locking ring 51 that is snapped onto and permanently attached to the cartridge 42. The cartridge 42 comprises two cylindrical containers or chambers 43 of equal cross-sectional area, two distal outlets 45 and 46, and an attaching means 47 for attaching the locking ring 51 and for limiting its rotational movement. The form of the attaching means 47 is a circular edge 49 with two lugs 44 of same width and arranged around the two distal outlets with a circular undercut 48 at its base.

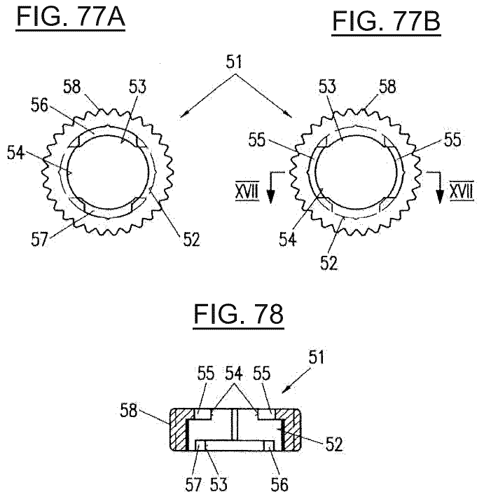

The locking ring 51 (see FIGS. 77A and 77B) and 17, snaps over circular edge 49 of the attaching the cartridge and remains attached to it. The locking ring 51 has an inner circular groove 52 forming a cartridge side edge 53 and a mixer side edge 54. The cartridge side edge 53 has two opposed cutouts 55, the width of which corresponds to the lugs 44 of the attaching, means whereby the inner diameter of the cartridge side edge 53 is slightly smaller than the outer diameter of the circular edge 49 of the attaching the cartridge. For snapping the locking ring to the cartridge, the ring is positioned so that the cutouts of its cartridge side edge are placed above the lugs of the attaching means and the ring is then pushed onto the cartridge so that the remaining cartridge side edge of the locking ring slides into the circular undercut 48 of the attaching means. The locking ring is also provided with a serration 58 for better manual gripping.

The mixer side edge 54 has two opposite cutouts 56 and 57 of different width corresponding to the lugs 10 and 11 of the mixer for insertion in one position only. These two cutouts are arranged at 90° to the cutouts 55 of the cartridge side edge.

Thus, when the mixer 59 is to be attached to the locking ring on the cartridge and the locking ring is rotated by 90°, the remaining inside flange parts of both the cartridge side edge and the mixer side edge serve as bayonet retaining means to encompass the mixer lugs 10 and 11 as well as the lugs 44 of the attaching means 47 of the cartridge for strong securement.

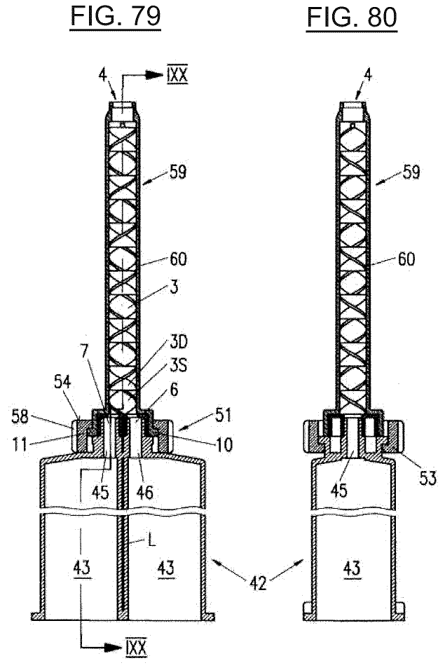

FIGS. 79 and 80 show cartridge 42 of FIG. 75 with a mixer 59, which is similar to mixer 1 of FIG. 62 with the same mixer inlet section 5 with separate female inlets 6 and 7, except that the housing 60 is not rotatable around the integral internal parts of the mixer and has no ribs 8, and the two bayonet lugs 10 and 11 are of different widths. FIG. 79 shows the mixer introduced within the locking ring 51 with the locking ring in its locked position and FIG. 80 shows a section along the line XIX-XIX in FIG. 79 of the same assembly at 90°. It is evident that a mixer with separated inlet chambers can be attached likewise and also that a cartridge can be one having containers with different cross-sectional areas as in FIG. 66.

The above described system of the coded attachment of the mixer also allows for the coded attachment of closure caps, adapters etc., thus preventing cross contamination and allowing closure cap re-use.

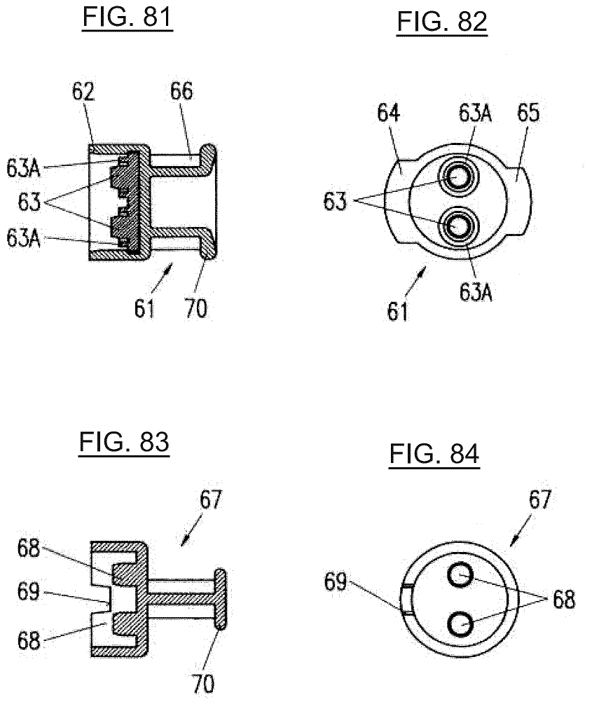

The first embodiment of a coded closure cap 61, FIGS. 81 and 82, consists of two parts. The insert 62 has two male plugs 63 for closing the outlets of a cartridge, for example the distanced outlets 14 and 15 of cartridge 12 of FIG. 64.

In this embodiment it is shown how the sealing effect of a plug at the cartridge outlet can be improved by providing the male plug 63 with a second rim 63A reaching over the female cartridge outlet. The provision of such a male plug with a circumferential rim is of course not limited to this example.

The rotatable attaching means has two bayonet lugs 64 and 65 of different widths corresponding to the lugs 10 and 11 of mixer 1 of FIG. 62. The outer surface of the cap is provided with ribs 66 and a collar 70 for better gripping. The coded attachment of the closure cap to cartridge 12 or 24 is analogous to the attachment of mixer 1.

The second embodiment, FIGS. 83 and 84, consists of a coded closure cap 67, which also has two plugs 68 for closing the outlets of a cartridge, for example the distanced male outlets 14 and 15 of cartridge 35 of FIG. 70, and a slot 69 similar to slot 30 at mixer 25 for coded cooperation with nose piece 36 of cartridge 35. The outer surface of the cap is also provided with a collar 70 for better manual gripping. The attachment of the cap to cartridge 35 is achieved with coupling ring 31 of FIG. 72, analogous to the attachment of mixer 25 to that cartridge.

The third embodiment of a coded closure cap 71, FIGS. 85 and 86, is similar to the second embodiment and comprises two plugs 72 for closing the distanced male outlets 45 and 46 of cartridge 42 of FIG. 75. FIG. 86 shows the cartridge side of the closure cap with two bayonet lugs 73, 74 of different width and diametrically opposed on the edge facing the cartridge. This closure cap is attached by the locking ring 51 of FIGS. 79 and 80 and is also provided with a collar 70 for better manual gripping.

The ring-shaped bayonet attachment the cartridge ensures a better stability of its outlet area and stronger retaining of the bayonet lugs compared with prior art bayonet attachment means.

In the case of utilizing the advantages of the ring-shaped bayonet socket alone and without the need for coded attachment, the bayonet lugs 10 and 11, 32 and 33, 64 and 65 at the mixer or closure cap or accessory as well as the corresponding bayonet cutouts 19 and 20 at the retaining means at the cartridge or 56 and 57 at the locking ring 51, can have the same widths. This applies also in the case when more than two lugs and corresponding cutouts are used, for example three or four respectively.

The FIGS. 87 to 89 show a further embodiment with an inverse bayonet arrangement as compared with those of the bayonet arrangement of the mixer and cartridge according to FIGS. 62 to 65. FIG. 87 shows a mixer 80 comprising a mixer housing 81 with mixer outlet 4 and a mixer inlet section 82 containing two separated inlet parts 83 and 84 followed by a separating element 3S, which in
turn is fixedly attached to a properly aligned element 3D of the mixer element group 3. Also, this mixer is attached to the cartridge by matching the coding mixer and cartridge by pressing the mixer onto the cartridge and by
rotating the mixer housing 81 of the mixer about the integral internal mixer parts comprising separate female inlets 83 and 84, the separating element 3S and the mixer element group 3. The mixer element group or part thereof could also
be prealigned and be fixedly assembled within the mixer housing.

The mixer housing 81 is provided with longitudinal ribs 8, which end at the larger diameter 85. The larger end of the mixer housing has a nose piece 89, which provides a highly visible coded guide for alignment and insertion into the slotted prong 90 of the cartridge. The mixer housing 81 is also provided with a ring-shaped bayonet socket attachment means 100 comprising two bayonet flange parts 94 and 95 acting as bayonet retaining means, having two cutouts 96 and 97 in between.

The cartridge 86 has two cylindrical containers 87 and 88 with the distanced outlets 14 and 15 for fitting and sealing within the mixer inlet section 82. The cartridge front 86A is provided with a slotted prong 90 and a guide piece 91 for preventing incorrect insertion of the mixer and further with two bayonet flanges 92 and 93 with tapered wedge-shaped edges. corresponding in width with the mixer cutouts 96 and 97, and with reduced diameter cutouts 98 and 99 in between.

For attaching the mixer to the cartridge, the mixer inlet part 82 is introduced into the cartridge by aligning the nose piece 89 of the mixer housing within the slotted prong 90 while the part 91 acts as a guide piece as the mixer inlets are pushed onto and over the cartridge distanced male outlets 14 and 15 such that the cartridge flanges 92 and 93 correspond to and enter within the mixer cutouts 96 and 97. Upon rotating the mixer housing, the mixer bayonet flange parts 94 and 95 progressively move against the cartridge flanges 92 and 93, because of their tapered wedge shaped depth, forcing the mixer 80 against the cartridge front 86A. During this mixer to cartridge attachment, the mixer housing 81 rotates 90° about the stationary integral internal mixer parts. The above bayonet arrangement, wherein the ring-shaped bayonet socket is at the accessory, as shown for a rotating mixer housing, can also be used in analogous manner for previously shown embodiments and for the closure caps, with the exception of the locking ring solutions. Alternative coding means arranged around the outer periphery of the mixer housing are possible or is achieved by different widths of cutouts and matching flange parts.

FIGS. 90 to 92 show a further embodiment wherein the mixer is provided with male inlet parts fitting into and sealing within the female cartridge outlets.

FIG. 90 shows a mixer 101 comprising a mixer housing 102 with mixer outlet 4 and a mixer inlet section 103 containing two separate male inlets 104 and 105 followed by a separating element 3S which in turn is fixedly attached to a properly aligned first dividing element 3D of the mixer element group 3. Also, this mixer is attached to the cartridge by matching the coding the mixer to the coding
the cartridge, by pressing the mixer onto the cartridge and by rotating the mixer housing 102 about the integral internal mixer parts comprising separate male inlets 104 and 105, the separating element 3S and the mixer element group 3. The mixer element group or part thereof could also be prealigned and be fixedly assembled within the mixer housing.

The mixer housing 102 is provided with longitudinal ribs 8 which end at the larger diameter 106, the two lateral ends of, which are formed as bayonet lugs 107 and 108, FIG. 91, cooperating with the bayonet retaining the cartridge. The bayonet lugs do not have the same width, lug 107 being larger.

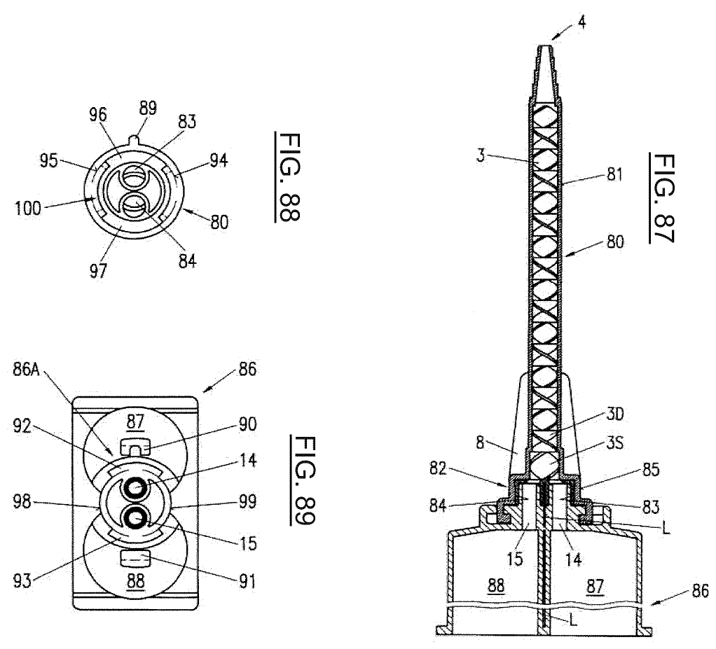

The cartridge 109, FIG. 92, has two cylindrical containers 110 and 111 with the distanced female outlets 112 and 113 for fitting and sealing over the male mixer inlets 104 and 105. The cartridge front 114 is provided with the same bayonet means 16 as the cartridge of FIG. 65, comprising a ring-shaped bayonet socket.

FIGS. 93 to 95 show a further embodiment wherein the mixer is provided with a male and a female inlet part fitting and sealing into/over the female/male cartridge outlets.

FIG. 93 shows a mixer 115 comprising a mixer housing 116 with outlet 4 and a mixer inlet section 117 containing a separate male inlet 118 and a separate female inlet 119 followed by separated chambers 117A and 117B, which in turn are fixedly attached to a properly aligned first dividing element 3D of the mixer element group 3. Also, this mixer is attached to the cartridge by pressing the mixer onto the cartridge and by rotating the mixer housing 116 about the integral internal mixer parts comprising separate male inlets 118 and 119, the separated chambers 117A and 117B and the mixer element group 3. The mixer element group or part thereof could also be prealigned and be fixedly assembled within the mixer housing.

The mixer housing 116 is provided with longitudinal ribs 8, which end at the larger diameter 120, the two lateral ends of which are formed as bayonet lugs 121 and 122, FIG. 94, cooperating with the bayonet retaining the cartridge. The bayonet lugs do not have the same width, bayonet lug 121 being larger.

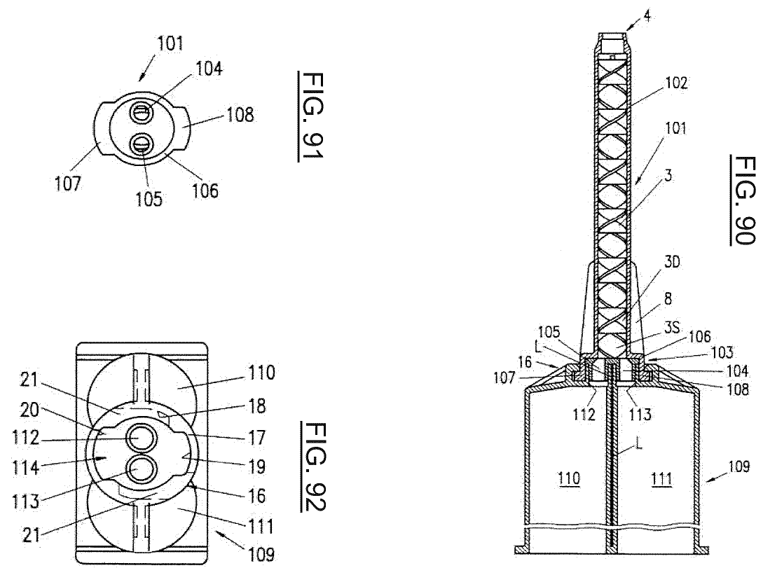

The cartridge 123 has two cylindrical containers 124 and 125 with one distanced male outlet 126 and one distanced female outlet 127 for, respectively, fitting and sealing within the separate female inlet 119 and over the separate male inlet
118 of the mixer. The cartridge front 128, FIG. 95, is provided with the same bayonet means 16 as the cartridge of FIG. 65, comprising a ring shaped bayonet socket.

The embodiments of FIGS. 96 and 104 show sector-shaped bayonet sockets instead of complete ring-shaped ones. The function and the attaching of the accessory are the same as in the previous embodiments, so that the three different embodiments of the bayonet means are illustrated in one respective example of mixer and cartridge. It is obvious that the sector-shaped bayonet socket and similar means can be provided on all other embodiments also.

FIG. 96 shows a mixer-cartridge assembly with a mixer 130 comprising a mixer housing 131 with outlet 4 and a mixer inlet section 132 containing two separate male inlets 133 and 134 followed by separating chambers 133A and 134A which in turn are fixedly attached to a properly aligned first dividing element 3D of the mixer element group 3. Also, this mixer is attached to the cartridge by pressing the mixer
onto the cartridge and by rotating the mixer housing 131 about the integral internal mixer parts comprising separate male inlets 133 and 134, the separated chambers 133A and 134A and the mixer element group 3. The mixer element group or part thereof could also be prealigned and be fixedly assembled within the mixer housing.

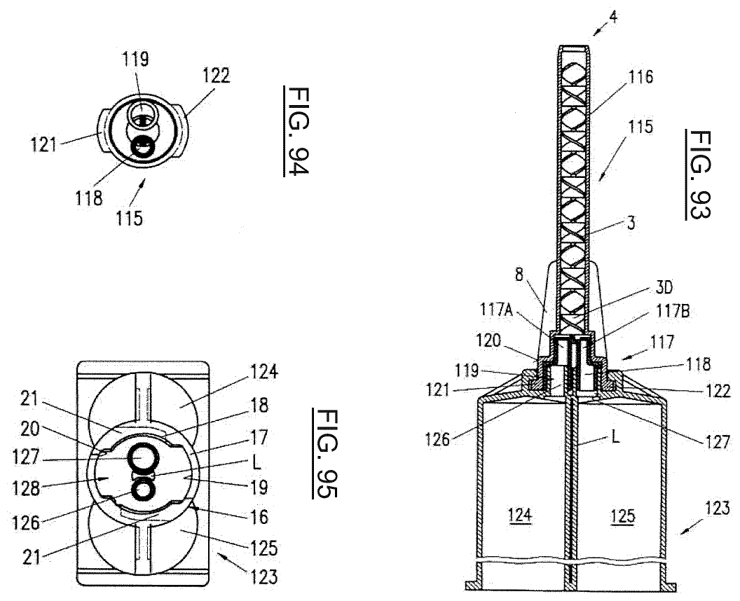

The mixer housing 131 is provided with longitudinal ribs 8 which end at the larger diameter 135, the two lateral ends of, which are formed as bayonet lugs 136 and 137, FIG. 98, cooperating with the sector-shaped bayonet sockets 145, 146, serving as bayonet retaining the cartridge. The bayonet lugs have the same width and are provided each with a rib 136A and 137A at its end which both strengthen each lug and acts as a stop as well as ensuring that the mixer can be turned and attached in o n e direction only. The upper surface of the lugs can have inclined surface parts so as to enforce the locking ability by an axial load. Corresponding inclined surface parts can also be located on the corresponding surface of the cartridge sector shaped bayonet sockets.

The cartridge 138 has two cylindrical containers 139 and 140 with two distanced female outlets 141 and 142 for receiving and sealing over the separate male inlets 133 and 134. The cartridge front 143, FIG. 97, is provided with bayonet means comprising sector-shaped bayonet sockets 145, 146 which act as prongs and are closed on one side by a rib 145A and 146A which connects to the cartridge end wall so as to stiffen and increase the strength of the bayonet prong. The cutouts 149 and 150 between the sector shaped bayonet sockets allow for the introduction of the mixer bayonet lugs 136 and 137.

In this embodiment the bayonet lugs and the sector shaped bayonet sockets have approximately the same width. The coding is achieved by other coding means on the mixer and on the cartridge. The cartridge front 143 is provided with a T-shaped protrusion 151 arranged between the two outlets and the mixer inlet face is provided with a similar protrusion 152 arranged off centre between the mixer inlets, see FIGS. 97 and 98.

The two T-shaped coding means allow the attachment of the mixer in one orientation only since, when putting the mixer onto the cartridge such that when the two protusions are laying one upon the other, they will prevent the introduction of the mixer inlets into the cartridge outlets and also any contact between the cartridge outlets and the mixer inlets or plugs of closure means thus preventing cross contamination and prohibiting mixer/accessory attachment. It is obvious that the coding protrusions can have any shape other than a T-form, and could be, e.g., in the form of a keyway allowing only one defined position in which to introduce the mixer having a corresponding protrusion, or two differently shaped keyways and corresponding protrusions.

The coded alignment can be facilitated by visual coding means, e.g., a marking 153 at the cartridge outlet end and a marking 154 at the bayonet lug 137 of the mixer on the same side as the coding protrusion.

In the embodiment of FIGS. 99 to 101, the coding is achieved by cutouts of different widths between the lugs. FIG. 99 shows a mixer-cartridge assembly with a mixer 155 with a mixer housing 156, outlet 4 and integral internal mixer parts comprising two separate inlets 157 and 158 ending into a disc-shaped flange and followed by separated chambers 157A and 158A which in turn are fixedly attached to a properly aligned first dividing element 3D of the mixer element group 3. Also, this mixer is attached to the cartridge by pressing the mixer onto the cartridge and by rotating the mixer housing 156 about the integral internal mixer parts. The mixer element group 3 or part thereof, can also be prealigned and fixedly assembled within the mixer housing.

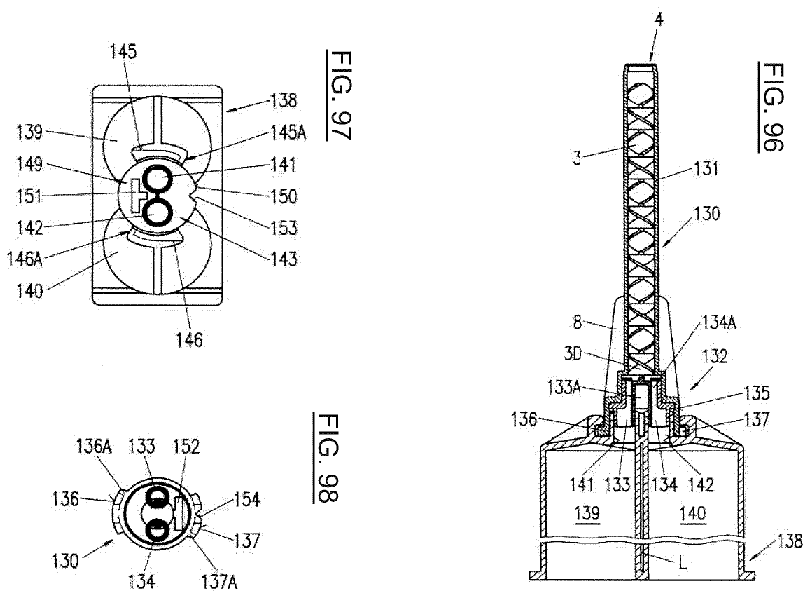

The mixer housing 156 is provided with longitudinal ribs 8, which end at the larger diameter 159, the two lateral ends of which are formed as bayonet lugs 160 and 161, FIG. 101, cooperating with the sector shaped bayonet retaining the cartridge. In this FIG. 99 and also in FIGS. 74, 93, 96 and 106 it is shown that the inlet end of the mixer housing has not only one cylindrical enlargement but two, e.g., one 159 at the inlet, lodging and sealing against the separate inlets 157, 158, followed by the second part 159A having an intermediate diameter and lodging and sealing against the separating means 157A, 158A. The bayonet lugs have the same widths but the gaps or cutouts 194, 195 between them are different, corresponding to the different widths of the sector shaped bayonet sockets on the cartridge.

These bayonet lugs 160, 161, can be provided each with a rib 167, FIG. 101, on the reverse side of the mixer inlet which both strengthen the lug and act as stop as well as limiting rotation in one direction only so as to prevent the mixer from being attached at 180° to the correct alignment. The upper surface of the lugs can have inclined parts, not shown, so as to enforce the locking and sealing ability by an axial force. Corresponding inclined parts, not shown, can also be located on the corresponding surface of the cartridge sector shaped bayonet sockets.

The cartridge 162 has two cylindrical containers 163 and 164 with two distanced female outlets 165 and 166 for receiving and sealing over the separate male inlets 157 and 158. The cartridge front 168, FIG. 100, is provided with bayonet means, comprising two sector-shaped bayonet sockets.

In FIG. 100, the bayonet means at the cartridge comprises two diametrically opposed sector-shaped bayonet sockets 169 and 170 acting as bayonet prongs for the bayonet lugs of the mixer, the two sockets having different widths, socket 169 having the greater width. The two cutouts 171 and 172 between the sockets allow for the introduction of the corresponding mixer bayonet lugs 160 and 161 into the sector shaped bayonet sockets 169, 170. As shown in this Figure, the passages of the bayonet sockets 169 and 170 commence as straight passages but become curved from the mid point onwards so as to achieve a greater strength against bayonet lug axial forces.

The passages can be wholly curved, without straight parts, and wholly or partly curved passages can also be provided on the ring-shaped bayonet attachment means.

In order to prevent any inadvertent contact whatsoever of the mixer or accessory inlet or inlets with the cartridge outlet or outlets by any form of tilting or tipping of one against the other during incorrect alignment the larger cutout 195 at the mixer is provided with a V-shape nose 192 corresponding to a V-shape incision 193 at the larger socket 169 such that the mixer is kept outside of the narrower bayonet socket 170 by the V-shape nose 192.

In this embodiment also the coded alignment can be facilitated by visual coding means, e.g., marking 153 at the cartridge and marking 154 at the corresponding lug.

In case no univocal attachment of a mixer to the cartridge 162 is necessary the cutouts between the lugs of the mixer must be large enough to fit over the larger retaining the cartridge, whereas the visual coding means rest the same as previously described.

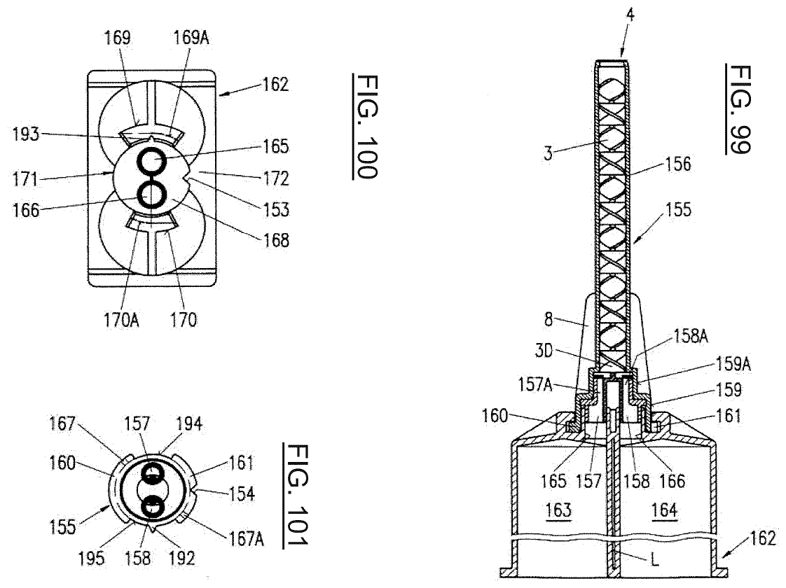

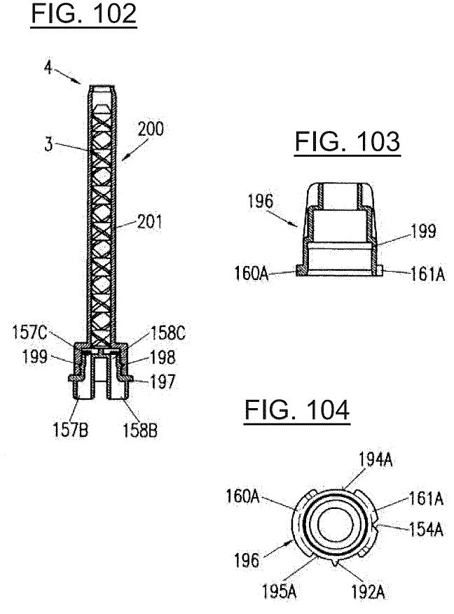

FIGS. 102 to 105 show a similar arrangement to that of the FIGS. 99 to 101 except that the mixer 200 is separate from coupling ring 196, the latter being rotated about the stationary mixer during the final rotary locking attachment of the coupling ring bayonet lugs 160A, 161A, into the sector shaped bayonet sockets 169, 170 of the cartridge 162.

FIG. 102 shows mixer 200 with the outlet 4 and comprising a housing 201 containing the mixer element group 3 in alignment with inlet part 197, the latter only partially contained within the mixer housing and comprising separate male inlets 157B, 158B and separate chambers 157C, 158C. A ridge 198 lodges and seals the inlet part 197 within the mixer housing. The coupling ring 196 is preassembled and prealigned with the mixer inlet part 197 via a groove 199, FIG. 102, in the coupling ring 196. FIG. 104 shows coupling ring 196 with the same coded bayonet lugs 160A, 161A, cutouts 194A, 195A, visual coding 154 and V-shape nose coding 192A as used in the embodiment according to FIG. 101.

FIG. 105 shows the mixer 200 and the cartridge 162 when assembled together. Prior to such assembly, the coupling ring 196 can be pre-assembled to the mixer under sufficient tension such that both components are held together in the correct relative alignment for initial visual coded and initial axial mechanical coded contact and attachment of the mixer inlets 157B, 158B to the cartridge outlets 165, 166 on the cartridge prior to the final rotary locking attachment of the coupling ring as described above. In this embodiment therefore, there is no rotation of the mixer housing 201 about the mixer inlet part 197 and element group 3 during attachment.

In the embodiment according to FIGS. 106 to 108 the sector-shaped bayonet sockets are at the mixer and the bayonet lugs at the cartridge, in analogy to the embodiment according to FIGS. 87 to 89.

FIG. 105 shows a mixer-cartridge assembly with a mixer 173 comprising a mixer housing 174 with outlet 4 and a mixer inlet section 175 containing the integral internal parts comprising two separate male inlets 176 and 177 followed by separated chambers 176 A and 177A which in turn are fixedly attached to a properly aligned first dividing element 3D of the mixer element group 3. Also, this mixer is attached to the cartridge by pressing the mixer onto the cartridge and by rotating the mixer housing 174 about the separate male inlets 176 and 177, the separated chambers 176A and 177A and the mixer element group 3. The mixer element group or part thereof could also be pre-aligned and be fixedly assembled within the mixer housing.

The mixer housing 174 is provided with longitudinal ribs 8, which end at the larger diameter 178, the two lateral ends of which are formed as two diametrically opposed sector-shaped bayonet sockets 179 and 180 (see FIG. 104) acting as prongs which are both closed at one side by a rib 179A and 180A connecting to the mixer wall so as to stiffen and increase the strength of the bayonet prong. The cutouts 181 and 182, between the sockets, allow for the introduction of the cartridge bayonet lugs cooperating with the bayonet retaining the mixer.

The cartridge 183 has two cylindrical containers 184 and 185 with two distanced female outlets 186 and 187 for fitting and sealing over the separate male inlets 176 and 177. The cartridge front 188, FIG. 103, is provided with bayonet means, comprising sector-shaped bayonet lugs 190 and 191 having the same width and each being provided with a rib 190A and 191A at its end which strengthens the lug and act as a stop as well as limiting rotation in one direction only so as to prevent the mixer from being attached at 180° to the correct alignment. The upper surface of the lugs can have inclined surface parts, not shown, so as to enforce the locking ability by an axial load. Corresponding inclined surface parts, not shown, can also be located on the corresponding surface of the mixer sector shaped bayonet sockets.

The lugs and the cutouts have approximately the same width. Thus, the required coding is achieved by other coding means on the mixer and on the cartridge. Therefore, the cartridge front 188 is provided with the T-shaped protrusion 151 arranged between the two distanced female outlets and the mixer inlet face is provided with a similar shaped protrusion 152 arranged off center between the mixer inlets. See FIGS. 107 and 108.

The two T-shaped coding means allow the introduction of the mixer in one position only, since the placing of the mixer onto the cartridge is such that, when the two protusions are laving one upon the other, they will prevent the introduction of the mixer separate male inlets into the cartridge distanced female outlets as well as any contact between the cartridge outlets and the mixer inlets, thus prohibiting cross contamination and mixer/accessory attachment. It is obvious that the coding protrusions can have any shape other than a T-form.

There are situations where the T-shaped coding protrusion give not a 100% protection to warrant no cross-contamination. In the FIGS. 109 to 119 show several coding protrusions which are believed to warrant that no cross-contamination can occur even if the mixer is introduced onto the cartridge in the wrong sense. To this end the coding protrusions are arranged thus that no tilting around the axis connecting the centers of the two outlets of the cartridge, which could cause this contamination.

The cartridge 210 of FIG. 109 is similar to the cartridge 162 of FIG. 100 and has the same two cylindrical containers with two distanced female outlets 165 and 166 for receiving and sealing over the separate male inlets 157 and 158. The cartridge front 211 is provided with the bayonet means comprising two diametrically opposed sector-shaped bayonet sockets 169 and 170 acting as bayonet prongs for the bayonet lugs of the mixer, the two sockets having different widths, socket 169 having the greater width. The two cutouts 171 and 172 between the sockets allow for the introduction of the corresponding mixer bayonet lugs 160 and 161 into the sector shaped bayonet sockets 169, 170. As shown in this Figure, the passages of the bayonet sockets 169 and 170 commence as straight passages but become curved from the mid-point onwards so as to achieve a greater strength against bayonet lug axial forces.

In addition to the cartridge of FIG. 100, the front of this cartridge 210 is provided with a coding protrusions 212, consisting of two pins 213 arranged symmetrically to the axis connecting the centers of the outlets but asymmetrically as regards the transversal middle axis, e.g., on the side of one outlet.

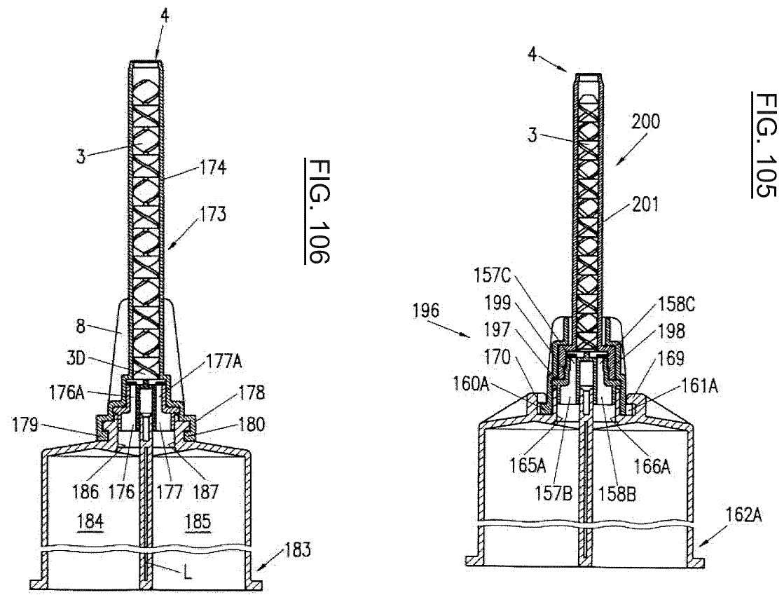

FIG. 110 shows a mixer 214 similar to the mixer 155 of FIG. 99 with a mixer housing 156, outlet 4 and integral internal mixer parts comprising two separate inlets 157 and 158 followed by separated chambers 157A and 158A, which in turn are fixedly attached to a properly aligned first dividing element 3D of the mixer element group 3. Also, this mixer is attached to the cartridge by pressing the mixer onto the cartridge and by rotating the mixer housing 156 about the integral internal mixer parts. The mixer element group 3 or part thereof, can also be prealigned and fixedly assembled within the mixer housing.

The mixer housing 156 is provided with longitudinal ribs 8, which end at the larger diameter 159, the two lateral ends of which are formed as bayonet lugs 160 and 161 cooperating with the sector shaped bayonet retaining the cartridge. This mixer 214 can also have two enlargements, e.g., one 159 at the inlet, lodging and sealing against the separate inlets 157, 158, followed by the second part 159A having an intermediate diameter and lodging and sealing against the separating means 157A, 158A. The bayonet lugs have the same widths but the gaps or cutouts 194, 195 between them are different, corresponding to the different widths of the sector shaped bayonet sockets on the cartridge, and have also ribs.

In addition to the mixer of FIG. 99 the inlet part of this mixer 214 is provided with the same coding protrusions 215 as those of the cartridge, consisting of two pins 216 and arranged in accordance to the pins 213 of the cartridge such that the mixer can only be introduced the correct way with regard to the other coding means without the possibility of tilting if introduced by force the wrong way.

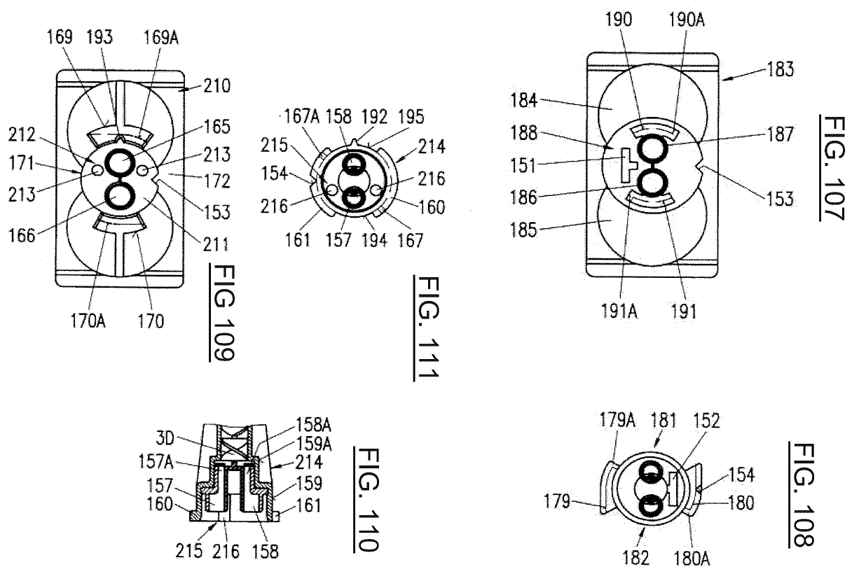

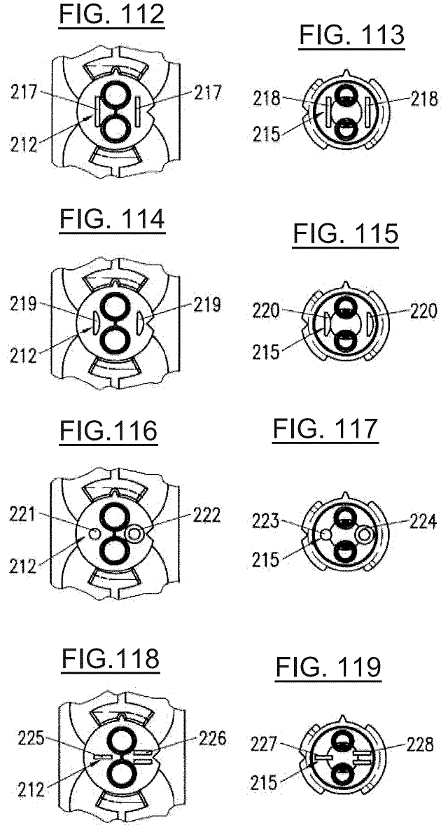

The FIGS. 112 to 119 show further arrangement and forms of coding protrusions 212, 215, whereby the cartridge as well as the mixer are always the same as in FIGS. 109 to 111 and only the coding protrusions are provided with numerals, the other parts being the same.

FIGS. 112 and 113 show a coding protrusion 212 on the cartridge front consisting of two bars 217 arranged symmetrically to the transversal middle axis of the cartridge but asymmetrically to the axis connecting the centers of the outlets. The two bars 218 of the mixer inlet part are arranged in accordance to those of the cartridge such that introduction and attachment of the mixer onto the cartridge is only possible in one position.

FIGS. 114 and 115 show a coding protrusion 212 on the cartridge front consisting of two D-shaped protrusion 219 arranged symmetrically to the transversal middle axis of the cartridge but asymmetrically to the axis connecting the centers of the outlets, with both flat sides looking in one direction. The two D-shaped protrusions 220 of the mixer inlet part are arranged in accordance to those of the cartridge such that introduction and attachment of the mixer onto the cartridge is only possible in one position.

FIGS. 116 and 117 show a coding protrusions 212 on the cartridge front consisting of a male plug 221 and a female plug 222 arranged symmetrically. The male plug 223 and the female plug 224 of the mixer inlet part are arranged in accordance to those of the cartridge such that introduction and attachment of the mixer onto the cartridge is only possible in one position.

FIGS. 118 and 119 show a particularly effective coding protrusions 212 on the cartridge front consisting of a bar 225 on one side of the axis connecting the centres of the outlets and two spaced bars 226 on the other side of this axis, arranged symmetrically to the transversal middle axis of the cartridge. The single bar 227 and the double bar 228 of the mixer inlet part are arranged in accordance to those of the cartridge such that introduction and attachment of the mixer onto the cartridge is only possible in one position.

All these coding protrusions prevent efficiently tilting of the mixer during attachment to the cartridge and hence cross-contamination.

The coded alignment can be facilitated by visual coding means, e.g., the marking 153 at the cartridge, opposite the protrusion and the marking 154 at the lug of the mixer near the coding protrusion.

It follows from the embodiment according to FIGS. 93 to 95 that the mixer inlets and the cartridge outlets can be either female or male respectively and it follows also that it is possible to provide the mixer with o n e female and one male inlet fitting over/into the corresponding male/female outlet of the cartridge.

This latter arrangement provides for a further coding means since only one position is possible for matching the mixer or closure means to the cartridge. This mixed arrangement of coding and coding means is independent from the manner of attachment with a coupling ring, locking ring or rotatable mixer housing.

While the different widths of the bayonet lugs provide for a distinct coding means, it might be advantageous to enhance this effect by visualisation of the coding by optical means such as different colors, a notch and a marking or by providing one lug of the accessory with a cutout and the corresponding nose at the cartridge bayonet means. This can be done either for visual marking one of the coding parts or for the coding itself.

Cartridges separated with one single wall, e.g., according to U.S. Pat. No. 5,333,760, cannot exclude chemical migration through such a single wall separation barrier and therefore separation at the cartridge outlets is not sufficient
to prevent migration and therefore a reaction within the cylinders during storage.

It follows in particular from the FIGS. 5-5, 75, 87, 90, 93, 96, 99 and 102 that it is advantageous to provide for a single piece cartridge consisting of two complete, preferably cylindrical containers, which are substantially separated by an air gap L in between, see e.g. FIG. 93. This assures a total chemical separation along the whole length where the chemicals are contained, ahead of the cylinder pistons, all the way to the top of the outlets where, during storage, a closure means is installed. During dispensing, this separation is further maintained within the mixer up to the first dividing element 3D of the mixer element group.

The present aspect, is not limited to air gap separated containers and applies as well to cartridges with containers separated by one single wall according to FIG. 64.

It follows from the above description that the inventive cartridge to accessory attachment combination provides in particular for cartridge containers separated by an air gap up to and including the individual outlets and for a port to port coded alignment for same or dissimilar size ports, with no cross-contamination caused by rotation or random attachment, while maintaining separation past the interface and well into the mixer, so as to hinder the spreading of any possible reaction and plugging of the components at the interface and back into the cartridge outlets. This combination also provides optimization of the mixing performance especially, but not uniquely, for ratios other than 1:1.

While the foregoing description and the drawing of the cartridge embodiments pertained to multi-component cartridges with side-by-side containers the teaching of the present aspect is not limited thereto and can be applied as well to cartridges with concentric containers or otherwise arranged and formed containers.

However, the principle of coded attachment ensures both the correctly aligned connection of a mixer or accessory to cartridge outlets since only one position of the mixer or accessory is possible and, in the case of the re-connection of mixer or closure cap to a cartridge, eliminates the possibility of cross-contamination.

Furthermore, and in respect to mixers, all the above described embodiments have the advantage of comprising the minimum number of parts and of being compact, resulting in low molding and assembly costs since the whole inlet section comprising the separating means and the mixer element group is made in one piece. Also, the integral construction of this internal part ensures proper alignment,
thus, providing optimum mixing efficiency.

In the case of the first embodiment according to FIG. 62 when a relatively long mixer element group is used and where rotational friction between this mixer element group and the mixer housing might cause problems, it can be preferable to separate a part or the whole of the mixer element group from the separating the inlet section such that a part or the whole of the mixer element group can be fixedly assembled within the housing and therefore it rotates with the housing while connecting the mixer to the cartridge.

In this case—and as seen from the mixer inlet to the mixer outlet—the leading edge of the first element of the mixer element group, or of a portion thereof, must be fixedly assembled within the housing in a pre-aligned position.

Therefore, after rotating the housing so as to attach the mixer to the cartridge, correct alignment of the elements is achieved such that each of the two material streams leaving the separating means, or the first element group attached to the separating means, will be evenly divided by the leading edge of the first element of the element group, or portion thereof attached to the housing, for optimum mixing efficiency.

It is evident that instead of cylindrical inlets and outlets, D-shaped or differently shaped similar or dissimilar sized inlets and outlets are possible. Furthermore, the same principle can also be used for a dispensing device, or cartridge, for more than two components.

In addition to the accompanying set of claims, several side aspects of the present disclosure are described in the following.

### Supplementary First Aspect

A supplementary first aspect refers to a mixer arranged in a tube with a tube axis defining the general direction of a flow of materials for mixing, the mixer including at least one mixing element which comprises:
a plurality of deflecting plates disposed nonparallel to the tube axis;
   at least one first separating flange extending across the tube and having a first connecting boundary which is connected to at least some of the plurality of deflecting plates and a first open boundary which is spaced from the plurality of deflecting plates generally in the direction of the tube axis, a cross-sectional plane perpendicular to the tube axis across the first open boundary and the plurality of deflecting plates defining a first axial section in the tube, the at least one first separating flange dividing the first axial section into a plurality of subareas which include first blocked areas having at least one of the plurality of deflecting plates as a boundary and first open subareas not bounded by the deflecting plates, each first separating flange having one first open subarea to each side thereof; and
at least one second separating flange extending across the tube and having a second connecting boundary which is connected to at least some of the plurality of deflecting plates and a second open boundary which is spaced from the plurality of deflecting plates generally in the direction of the tube axis opposite from the at least one first separating flange, a cross-sectional plane perpendicular to the tube axis across the second open boundary and the plurality of deflecting plates defining a second axial section in the tube, the at least one second separating flange dividing the second axial section into a plurality of subareas which include second blocked areas having at least one of the plurality of deflecting plates as a boundary and second open subareas not bounded by the deflecting plates, each second separating flange having one second open subarea to each side thereof, the at least one second separating flange being nonparallel to the at least one first separating flange.

The above described mixer which includes a plurality of the mixing elements oriented along the tube axis forming a series of neighboring mixing elements, wherein each pair of neighboring mixing elements have the at least one first
separating flange of one neighboring mixing element adjacent and nonparallel to the at least one second separating flange of another neighboring mixing element.

The mixer of the supplementary first aspect which includes a plurality of the mixing elements oriented along the tube axis forming a series of neighboring mixing elements. wherein each pair of neighboring mixing elements have the first open subareas of one neighboring mixing element adjacent to and offset from the second open subareas of another neighboring mixing element.

The mixer of the supplementary first aspect, wherein the first separating flanges divide the first axial section into subsections of approximately equal sizes.

The mixer of the supplementary first aspect, wherein the at least one second separating flange crosses the at least one first separating flange at an angle of about 90°.

The mixer of the supplementary first aspect, wherein the first axial section and the second axial section are approximately equal in size.

The mixer of the supplementary first aspect which includes a plurality of the mixing elements oriented along the tube axis, wherein at least one of the mixing elements has a length along the tube axis defined between the first open boundary of the at least one first separating flange and the second open boundary of the at least one second separating flange, the tube has a maximum tube diameter, and the length is smaller than the maximum tube diameter.

The mixer of the supplementary first aspect, wherein the length is smaller than half of the maximum tube diameter.

The mixer of the supplementary first aspect, wherein the plurality of deflecting plates lie in a common plane.

The mixer of the supplementary first aspect, wherein the plurality of deflecting plates form a single plate.

The mixer of the supplementary first aspect, wherein at least one of the plurality of deflecting plates is inclined by an angle (alpha) relative to a cross-sectional plane of the tube which is
perpendicular to the tube axis.

The mixer of the supplementary first aspect, wherein the angle (alpha) is less than 30°.

The mixer of the supplementary first aspect which includes a plurality of the mixing elements oriented along the tube axis, wherein the mixing elements form a monolithic structure.

The mixer of the supplementary first aspect, wherein the monolithic structure is made by injection molding.

The mixer of the supplementary first aspect which includes a plurality of the mixing elements oriented along the tube axis forming a series of neighboring mixing elements, wherein the first open boundary of each mixing element is adjacent to and spaced from the second open boundary of a neighboring mixing element.

The mixer of the supplementary first aspect, further comprising a plurality of connection elements which connect each mixing element with the neighboring mixing element.

The mixer of the supplementary first aspect, wherein the tube is square or circular in cross-section.

The mixer of the supplementary first aspect, wherein the at least one first separating flange and/or the at least o n e second separating flange have strengtheners or flow deflectors.

The mixer of the supplementary first aspect which includes a plurality of the mixing elements oriented along the tube axis forming a series of neighboring mixing elements, wherein the at least one first separating flange of each mixing element has a slot with which the at least o n e second separating flange of a neighboring mixing element cooperates to connect the neighboring mixing elements together.

The mixer of the supplementary first aspect, wherein at least one of the at least one first separating flange, the at least one second separating flange, and the plurality of deflection plates is nonplanar.

The mixer of the supplementary first aspect, wherein at least one of the at least one first separating flange, the at least one second separating flange, and the plurality of deflection plates has a recess.

The mixer of the supplementary first aspect which includes a plurality of the mixing elements oriented along the tube axis, wherein the tube is conical tapering in the direction of the tube axis and the mixing elements are differently sized in accordance with
the tapering to fit inside the conical tube.

The mixer of the supplementary first aspect which includes a plurality of the mixing elements oriented along the tube axis, wherein at least one mixing element has different numbers of the first separating flange and second separating flange from another
mixing element.

Utilization of the mixer of the supplementary first aspect for mixing materials including plastics, resins, glues or other viscous materials, wherein the Reynolds number for the materials flowing through the mixer is less than 1.

### Supplementary Second Aspect

A supplementary second aspect refers to a static mixer comprising:
a bundle of chambered strings arranged in a tube and oriented in a direction of the tube, the chambered strings comprising a plurality of chambers each extending in the direction of the tube between two closed ends, the plurality of chambers including a plurality of mixing-active chambers and a plurality of re-layering chambers, each mixing-active chamber including first and second mutually adjacent side walls having four alternately disposed passages each providing communication with one of first and second neighboring mixing-active chambers downstream thereof and first and second neighboring mixing-active chambers upstream thereof, the plurality of mixing-active chambers being arranged into at least two sections spaced along the direction of the tube by the re-layering chambers, the re-layering chambers each having first, second and third lateral passages providing communication with neighboring chambers.

The mixer of the supplementary second aspect, wherein the re-layering chambers are arranged in pairs which are connected by one of the first, second and third lateral passages of each re-layering chamber.

The mixer of the supplementary second aspect, wherein each pair of the re-layering chambers are directly connected.

The mixer of the supplementary second aspect, wherein the plurality of chambers further include intermediate chambers having first and second lateral passages and each pair of the re-layering chambers are indirectly connected by one of the intermediate chambers.

The mixer of the supplementary second aspect, wherein the bundle has four chambered strings.

The mixer of the supplementary second aspect, wherein the mixing-active chambers are substantially formed alike.

The mixer of the supplementary second aspect, wherein the mixing-active chambers connected by the passages between adjacent chambered strings are so arranged as to be displaced by half a chamber length in the direction of the tube with respect to one another.

The mixer of the supplementary second aspect, wherein the bundle has nine chambered strings, only eight of the nine chambered strings comprise mixing-active chambers, and one remaining chambered string comprises intermediate chambers which provide indirect connections between the mixing-active chambers.

The mixer of the supplementary second aspect, wherein some of the plurality of chambers of the chambered strings include at least one passage partially bounded by a rib for deflecting a flow through the passage.

The mixer of the supplementary second aspect, wherein the plurality of chambers of the chambered strings have substantially a form of rectangular prisms.

The mixer of the supplementary second aspect, wherein the plurality of chambers of the chambered strings have passages which are substantially rectangular.

The mixer of the supplementary second aspect, wherein the chambered strings include walls separating adjacent chambers with the passages of the adjacent chambers formed through the walls,
each wall having a relatively small thickness so that a square of the wall thickness is substantially smaller than an area of one of the passages through the wall.

The mixer of the supplementary second aspect, wherein the bundle of chambered strings is formed by injection molding.

The mixer of the supplementary second aspect, wherein the bundle of chambered strings is reinforced by strips which are arranged at a periphery of the bundle in the direction of the tube.

The mixer of the supplementary second aspect, wherein the bundle of chambered strings is in the form of a monolithic structure.

### Supplementary Third Aspect

A first embodiment of a supplementary third aspect refers to a static mixer comprising mixing elements for separating the material to be mixed into a plurality of streams, as well as means for the layered junction of the same, including a transversal edge and guide walls that extend at an angle to the transversal edge, as well as guide elements arranged at an angle to the longitudinal axis and provided with openings,
wherein the mixing element comprises a transversal edge and a following transversal guide wall and at least two guide walls ending in a separating edge each with lateral end sections and with at least one bottom section disposed
between the guide walls, thereby defining at least one opening on one side of the transversal edge and at least two openings on the other side of the transversal edge.

A second embodiment of the supplementary third aspect refers to a static mixer comprising mixing elements for separating the material to be mixed into a plurality of streams, as well as means for the layered junction of the same, including separating edges and a transversal edge that extends at an angle to the separating edges, as well as deflecting elements arranged at an angle to the longitudinal axis and provided with openings, wherein the mixing element comprises at least two separating edges with following guide walls with lateral end sections and with at least one bottom section disposed between the guide walls, and a transversal edge arranged at one end of a transversal guide wall, thereby defining at least one opening on one side of the transversal edge and at least two openings on the other side of the transversal edge.

The mixer of one of the two embodiments of the supplementary third aspect, wherein the sections of the guide walls are plane and arranged at a mutual angle.

The mixer of one of the two embodiments of the supplementary third aspect, wherein the enclosure of the mixer has a round cross-section.

The mixer of one of the two embodiments of the supplementary third aspect, wherein the enclosure of the mixer has a rectangular cross-section, the at least two separating edges with the following guide walls are arranged perpendicularly to the at least one transversal edge with the transversal guide wall, and the lateral end sections and the bottom section are arranged perpendicularly to the guide walls.

The mixer of one of the two embodiments of the supplementary third aspect, wherein the guide walls are curved, the at least two guide walls having the separating edges at one end of the mixing element, ending in a transversal edge arranged at the other end of the mixing element.

The mixer of one of the two embodiments of the supplementary third aspect, wherein the enclosure of the mixer is round and the mixing element comprises at least two separating edges and one transversal edge connected by guide walls including two lateral end sections and at least one bottom section, the connecting guide walls forming a curved and continuous transition between the separating edges and the transversal edge.

The mixer of one of the two embodiments of the supplementary third aspect, wherein the successive mixing elements are each arranged in a position rotated about the longitudinal axis.

The mixer of one of the two embodiments of the supplementary third aspect, wherein the successive mixing elements are each rotated by 180° about the longitudinal axis.

A third embodiment of the supplementary third aspect refers to a static mixer comprising mixing elements for separating the material to be mixed into a plurality of streams, as well as means for uniting the same in a layered manner, including separating edges and a transversal edge that extends at an angle to the separating edges, as well as deflecting elements arranged at an angle to the longitudinal axis and provided with openings, wherein the mixer comprises mixing groups including mixing elements for the division into a plurality of streams, and wherein at least one re-layering element is disposed between the mixing groups.

The mixer of the third embodiment of the supplementary third aspect, wherein the mixer successively comprises a first mixing group including mixing elements, followed by a re-layering element which in turn is followed by a second mixing group, and so on, the entrance edge of the re-layering element extending essentially perpendicularly to the transversal edge of the last mixing element of the mixing group, and the second mixing group being reversed by 1800 with respect to the flow direction such that the lateral edge of the mixing element extends essentially perpendicularly to the outlet edge of the mixing helix.

The mixer of the first embodiment of the supplementary third aspect, wherein the height of the guide walls is greater than the height of the transversal guide wall.

The mixer of the second embodiment of the supplementary third aspect, wherein the height of the transverse guide wall is greater than the height of the guide walls.

The mixer of the first embodiment of the supplementary third aspect, wherein the height of the guide walls amounts to 1.1 to 2.0, preferably 1.5 times the height of the transversal guide wall.

The mixer of the second embodiment of the supplementary third aspect, wherein the height of the transversal guide wall amounts to 1.1 to 2.0, preferably 1.5 times the height of the guide walls.

The mixer of one of the first and the second embodiment of the supplementary third aspect, wherein the guide walls are internally and/or externally provided with inclined webs.

The mixer of one of the first and the second embodiment of the supplementary third aspect, wherein longitudinal webs are arranged between the guide walls of two adjacent mixing elements.

The mixer of one of the first and the second embodiment of the supplementary third aspect, wherein the bottom sections and the guide walls are provided with dead zone obturations.

An application of the mixer of the first embodiment of the supplementary third aspect in the case where the material first reaches the transversal edge,
wherein the mixing element is designed to divide the material stream into at least two streams and to divide the two streams into at least six streams at the exit while two mixed streams are directed to one side of the transversal wall and one mixed stream to the other side of the transversal wall.

An application of the mixer of the second embodiment of the supplementary third aspect in the case where the material first reaches the separating edges and the guide walls, wherein the mixing element is designed to divide the material stream into at least six streams and to direct a respective part of the streams to one side of the transversal edge and the other part of the streams to the other side of the transversal edge.

### Supplementary Fourth Aspect

A first embodiment of a supplementary fourth aspect refers to a static mixer for mixing together at least two components comprising a mixer housing, a mixing element arranged at least partly within the mixer housing and a mixer inlet section having at least two inlets provided at an input side and at least two outlets provided at an output

Surface. The at least two outlets are in fluid communication with the at least two inlets. The mixer housing, the mixing element and the mixer inlet section are formed as separate elements. The mixing element comprises a plug element and the mixer inlet section comprises a counter plug element engaging the plug element. The mixing element and the mixer inlet section are plugged together in a rotationally fixed manner by a plugged connection.

The static mixer according to the supplementary fourth aspect, wherein the mixing element and the mixer inlet section are held together in an axial direction by the plugged connection that is formed by the plug element and the counter plug element and/or by at least one element of the mixer inlet section cooperating with at least one element of the mixer housing.

The static mixer according to the supplementary fourth aspect, wherein the plugged connection, preferably between the plug element and the counter plug element, comprises a clamping connection and/or a frictional connection, such as at least one nose frictionally engaging one of the mixer inlet section and the mixing element, and/or a latching connection of the plug element and the counter plug element.

The static mixer according to the supplementary fourth aspect, wherein the mixing element and the mixer inlet section are aligned in a fixed predefined rotational angular relationship by the plug element and the counter plug element.

The static mixer according to the supplementary fourth aspect, wherein the plug element and the counter plug element comprise coding means, in particular a thickened end or a bulge cooperating with a corresponding recess or groove, allowing the mixing element and the mixer inlet section to be plugged together only in the predefined rotational angular relationship.

The static mixer according to the supplementary fourth aspect, wherein the plug element comprises a wall section provided at an input end of the mixing element and the counter plug element comprises a groove provided at the surface.

The static mixer according to the supplementary fourth aspect, wherein the wall section is arranged between the at least two outlets so as to separate the components leaving the at least two outlets before entering inlets of the mixing element.

The static mixer according to the supplementary fourth aspect, wherein the wall section has a straight planar shape, and/or comprises a thickened end, and/or has at least partially a U-shaped cross section, and/or has at least partially a T-shaped cross section.

The static mixer according to the supplementary fourth aspect, wherein the at least two inlets have respective inlet openings and the at least two outlets have outlet openings, with the outlet openings being formed in the output surface of the mixing inlet section. A surface area of at least one of the inlet openings is smaller than a surface area of the corresponding outlet opening.

The static mixer according to the supplementary fourth aspect, wherein the output surface of the mixer inlet section has an at least substantially slanted contour at an outlet side of the mixer inlet section with respect to a longitudinal axis of the static mixer, with the outlet side being disposed remote from the inlet side, with the at least substantially slanted contour of the output surface preferably being adapted to a shape of an inlet surface of the mixer housing.

The static mixer according to the supplementary fourth aspect, wherein the static mixer has a longitudinal axis and in that at least two flow paths extend between the at least two inlet and outlet openings. Each inlet and outlet opening has a geometric center, with the geometric center of at least one, preferably of each, of the at least two outlet openings being spaced less far apart from the longitudinal axis than the geometric center of at least one, preferably of each, of the at least two inlet openings.

The static mixer according to the supplementary fourth aspect, wherein in a region of the at least two outlets, the at least two flow paths are configured to cooperate with the mixer housing, preferably with an inlet surface of the mixer housing, to provide a component flow guide region at inlets of the mixing element. The at least two outlets of the mixer inlet section are preferably arranged to at least partly overlap with inlets of the mixing element, in particular with the inlets of the mixing element being formed by the mixing element and/or by spaces formed between the mixing element and an internal wall of the mixer housing.

The static mixer in accordance the supplementary fourth aspect, wherein at least one region of at least one of the at least two outlets adjacent to the corresponding outlet opening is configured such that its cross-section perpendicular to the respective one of the at least two flow paths is enlarged in comparison to the corresponding inlet, in particular such that the flow path extending between the inlet opening and the outlet opening is directed and enlarged in a direction towards at least one inlet of the mixer element.

The static mixer in accordance with the supplementary fourth aspect, wherein at least one recess is provided at an outlet side of the mixer inlet section, wherein one of the at least two outlets opens into a base of the at least one recess and a cross-sectional area of the at least one recess is preferably larger than a cross-sectional area of the one of the at least two outlets. The depth of the recess in the axial direction preferably amounts to at least a third, in particular to at least half of the diameter of the outlet, or is preferably equal to or larger than the diameter of the outlet, with the at least one recess in particular having a cross-sectional shape that deviates from a circle especially such that the at least one recess has an elongate shape that is in particular extended towards the longitudinal axis. Alternatively or in addition to this, the at least one recess is connected to the other one of the at least two outlets and/or to a further recess in a direction transverse to the longitudinal axis.

The static mixer in accordance with the supplementary fourth aspect, wherein the mixing element comprises a plurality of mixer elements arranged one after another for a repeated separation and recombination of streams of the components to be mixed, in particular in that either the mixing element comprises mixer elements for separating the material to be mixed into a plurality of streams, as well as means for the layered merging of the same, including a transverse edge and guide walls that extend at an angle to the transverse edge, as well as guide elements arranged at an angle to the longitudinal axis and provided with openings. The mixing element comprises a transverse edge and a following transverse guide wall and at least two guide walls ending in a separating edge each with lateral end sections and with at least one bottom section disposed between the guide walls, thereby defining at least one opening on one side of the transverse edge and at least two openings on the other side of the transverse edge. Alternatively, the mixing element comprises mixer elements for separating the material to be mixed into a plurality of streams, as well as means for the layered merging of the same, including separating edges and a transverse edge that extends at an angle to the separating edges, as well as deflecting elements arranged at an angle to the longitudinal axis and provided with openings. The mixing element comprises at least two separating edges with following guide walls with lateral end sections and with at least one bottom section disposed between the guide walls, and a transverse edge arranged at one end of a transverse guide wall, thereby defining at least one opening on one side of the transverse edge and at least two openings on the other side of the transverse edge.

A second embodiment of the supplementary fourth aspect refers to a dispensing apparatus comprising a multi-component cartridge and a static mixer as described above connected to the multi-component cartridge, with the multi-component cartridge preferably being filled with respective components.

A third embodiment of the supplementary fourth aspect refers to a method of assembling a static mixer, comprising a mixer housing, a mixing element and a mixer inlet section that are formed as separate elements. The method comprising the steps of: engaging a plug element of the mixing element and a counter plug element of the mixer inlet section; and guiding the engaged mixing element and mixer inlet section into the mixer housing to arrange at least a part of the mixing element within the mixer housing. The mixing element and the mixer inlet section are plugged together in a rotationally fixed manner by a plugged connection. The static mixer can preferably be further developed in accordance
with any one of the preceding configurations.

A fourth embodiment of the supplementary fourth aspect refers to the use of a static mixer in accordance with any one of the above described configurations or of the above described dispensing apparatus to dispense components from a multi-component cartridge via the static mixer.

It has to be noted that the features of all of the above described aspects of the present disclosure and the further described supplementary aspects can be combined in various manners as long as no technical aspects prohibit any combination. Thus, a skilled artisan will be able to image various possibilities of implementing the present disclosure without leaving the scope of protection defined by the appending claims.

1. A mixer for mixing at least two materials, the mixer being configured to be connected to a cartridge, and the mixer comprising:
a mixer housing;
a mixing element having a first end and a second end opposite the first end, a longitudinal axis extending therebetween, first and second entry openings arranged at the first end and an outlet opening arranged at the second end, the mixing element further being arranged at least partly within the mixer housing;
an alignment element configured to align the mixer at a predetermined angle relative to the cartridge; and
a connection element configured to connect the mixer to the cartridge by a form-fitting connection, and
the connection element being a click connection or a snap lock connection.

2. The mixer according to claim 1,
wherein the connection element is arranged at the mixer housing.

3. The mixer according to claim 1, further comprising
a release element configured to release the connection to detach the mixer from the cartridge.

4. The mixer according to claim 3,
wherein the release element is arranged at the mixer housing.

5. The mixer according to claim 3,
wherein the release element is a wing configured to be pressed against or pulled away from the connection element to release the connection element.

6. The mixer according to claim 3,
wherein the release element is one of two release elements arranged opposite from one another that are configured to release the connection of the connection element.

7. The mixer according to claim 3,
wherein the connection element is arranged at the release element.

8. The mixer according to claim 1.
wherein the alignment element is arranged at the mixer housing.

9. The mixer according to claim 1,
wherein the alignment element further comprises at least one alignment surface.

10. A mixing and dispensing assembly for mixing and dispensing at least two materials comprising:
a mixer to mix the at least two elements; and
a cartridge,
the mixer comprising
a mixer housing,
a mixing element having a first end and a second end opposite the first end, a longitudinal axis extending therebetween, first and second entry openings arranged at the first end and an outlet opening arranged at the second end, the mixing element further being arranged at least partly
within the mixer housing,
an alignment element configured to align the mixer at a predetermined angle relative to the cartridge, and
a connection element configured to connect the mixer to the cartridge by a form-fitting connection,
the connection element is a click connection or a snap lock connection.

11. The mixing assembly according to claim 10.
wherein the cartridge comprises a cartridge head having at least two outlet openings, with the cartridge head further being configured to be connected to the mixer at the predetermined angle.

12. The mixing assembly according to claim 10,
wherein the cartridge comprises connection elements complementary to the connection element and configured to engage with the connection element.

13. The mixing assembly according to claim 10,
wherein the cartridge further comprises an alignment portion configured to rest on the alignment element of the mixer.

14. The mixing assembly according to claim 13,
wherein the alignment portion comprises at least one alignment surface configured to align the cartridge with respect to the mixer by leaning against the alignment element of the mixer.

15. The mixer according to claim 1, further comprising
a click connection to detach the mixer from the cartridge.

16. The mixer according to claim 3,
wherein the release element is arranged at an outer surface of the mixer housing.

17. The mixer according to claim 3,
wherein the connection element is arranged at the release element at a surface facing the cartridge.

18. The mixer according to claim 6,
wherein the alignment element is arranged at an outer surface of the mixer housing, between the two release elements.

19. The mixing assembly according to claim 10,
wherein the cartridge head comprises connection elements complementary to the connection element and configured to engage with the connection element.

20. The mixing assembly according to claim 13,
wherein the alignment portion comprises at least one alignment surface configured to align the cartridge with respect to the mixer by leaning against the at least one alignment surface of the alignment element of the mixer.
